(19) United States
(12) Patent Application Publication
(10) Pub. No.: US 2024/0094819 A1
(43) Pub. Date: Mar. 21, 2024

(54) DEVICES, METHODS, AND USER INTERFACES FOR GESTURE-BASED INTERACTIONS

(71) Applicant: Apple Inc., Cupertino, CA (US)

(72) Inventors: Yiqiang NIE, San Francisco, CA (US); Giovanni M. AGNOLI, San Mateo, CA (US); Allison W. DRYER, Tiburon, CA (US); Jules K. FENNIS, Seattle, WA (US); Charles MAALOUF, Seattle, WA (US); Camille MOUSSETTE, San Francisco, CA (US); Giancarlo YERKES, San Francisco, CA (US)

(21) Appl. No.: 18/242,694

(22) Filed: Sep. 6, 2023

Related U.S. Application Data
(60) Provisional application No. 63/408,581, filed on Sep. 21, 2022.

(51) Int. Cl. G06F 3/01; G06F 3/04842

(52) U.S. Cl. CPC G06F 3/016; G06F 3/011; G06F 3/017; G06F 3/04842

(57) ABSTRACT

In some embodiments, the present disclosure includes techniques and user interfaces for performing operations using air gestures. In some embodiments, the present disclosure includes techniques and user interfaces for audio playback adjustment using gestures. In some embodiments, the present disclosure includes techniques and user interfaces for conditionally responding to inputs.

### CROSS-REFERENCE TO RELATED APPLICATIONS

This application claims priority to U.S. Provisional Patent Application No. 63/408,581, entitled “DEVICES, METHODS, AND USER INTERFACES FOR GESTURE-BASED INTERACTIONS,” filed Sep. 21, 2022, the contents of which are hereby incorporated by reference in their entirety.

### TECHNICAL FIELD

The present disclosure relates generally to computer systems that are in communication with a display generation component, one or more input devices, and, optionally, an external wearable device; the computer systems provide computer-generated experiences, including, but not limited to, electronic devices that provide virtual reality and mixed reality experiences via a display. More specifically, the present disclosure relates to techniques for performing operations using gestures (e.g., air gestures).

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for performing operations using gestures are cumbersome, inefficient, and limited. For example, systems that provide insufficient feedback for performing actions associated with virtual objects, systems that require inputs on specific hardware to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems using gestures more efficient and intuitive for a user. Such methods and interfaces optionally complement or replace conventional methods for providing and interacting with extended reality experiences. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment using gestures. Such methods and interfaces may complement or replace conventional methods for interacting with a three-dimensional environment using gestures. Such methods and interfaces reduce the number, extent, and/or the nature of the inputs from a user and produce a more efficient human-machine interface. For battery-operated computing devices, such methods and interfaces conserve power and increase the time between battery charges. Such methods can also improve the operational life of the device by reducing wear on input mechanisms (e.g., buttons).

In accordance with some embodiments, a method, performed at a computer system having one or more input devices is described. The method includes: at a computer system that is in communication with one or more input devices: detecting, via the one or more input devices, an air gesture that is performed by a hand and that includes a rotation of the hand; and in response to detecting the air gesture: in accordance with a determination that the air gesture satisfies a first set of criteria, wherein the first set of criteria includes a criterion that is satisfied when the air gesture was detected while the hand was performing a pinch gesture, performing a first operation based on the air gesture; and in accordance with a determination that air gesture does not satisfy the first set of criteria, forgoing performing the first operation based on the air gesture.

In accordance with some embodiments, a non-transitory computer-readable storage medium is described. The non-transitory computer-readable storage medium stores one or more programs configured to be executed by one or more processors of a computer system having one or more input devices, the one or more programs including instructions for: detecting, via the one or more input devices, an air gesture that is performed by a hand and that includes a rotation of the hand; and in response to detecting the air gesture: in accordance with a determination that the air gesture satisfies a first set of criteria, wherein the first set of criteria includes a criterion that is satisfied when the air gesture was detected while the hand was performing a pinch gesture, performing a first operation based on the air gesture; and in accordance with a determination that air gesture does not satisfy the first set of criteria, forgoing performing the first operation based on the air gesture.

In accordance with some embodiments, a transitory computer-readable storage medium is described. The transitory computer-readable storage medium stores one or more programs configured to be executed by one or more processors of a computer system having one or more input devices, the one or more programs including instructions for: detecting, via the one or more input devices, an air gesture that is performed by a hand and that includes a rotation of the hand; and in response to detecting the air gesture: in accordance with a determination that the air gesture satisfies a first set of criteria, wherein the first set of criteria includes a criterion that is satisfied when the air gesture was detected while the hand was performing a pinch gesture, performing a first operation based on the air gesture; and in accordance with a determination that air gesture does not satisfy the first set of criteria, forgoing performing the first operation based on the air gesture.

In accordance with some embodiments, a computer system having one or more input devices, comprising: one or more processors; and memory storing one or more programs configured to be executed by the one or more processors is described. The one or more programs include instructions for: detecting, via the one or more input devices, an air gesture that is performed by a hand and that includes a rotation of the hand; and in response to detecting the air gesture: in accordance with a determination that the air gesture satisfies a first set of criteria, wherein the first set of criteria includes a criterion that is satisfied when the air gesture was detected while the hand was performing a pinch gesture, performing a first operation based on the air gesture; and in accordance with a determination that air gesture does not satisfy the first set of criteria, forgoing performing the first operation based on the air gesture.

In accordance with some embodiments, a computer system having one or more input devices is described. The computer system comprises: means for detecting, via the one or more input devices, an air gesture that is performed by a hand and that includes a rotation of the hand; and means, responsive to detecting the air gesture, for: according to a determination that the air gesture satisfies a first set of criteria, wherein the first set of criteria includes a criterion that is satisfied when the air gesture was detected while the hand was performing a pinch gesture, for performing a first operation based on the air gesture; and according to a determination that air gesture does not satisfy the first set of criteria, for forgoing performing the first operation based on the air gesture.

In accordance with some embodiments, a computer program product, comprising one or more programs configured to be executed by one or more processors of a computer system having one or more input devices is described. The one or more programs include instructions for: detecting, via the one or more input devices, an air gesture that is performed by a hand and that includes a rotation of the hand; and in response to detecting the air gesture: in accordance with a determination that the air gesture satisfies a first set of criteria, wherein the first set of criteria includes a criterion that is satisfied when the air gesture was detected while the hand was performing a pinch gesture, performing a first operation based on the air gesture; and in accordance with a determination that air gesture does not satisfy the first set of criteria, forgoing performing the first operation based on the air gesture.

In accordance with some embodiments, a method, performed at a computer system having one or more input devices is described. The method includes: at a computer system that is in communication with one or more input devices: detecting, via the one or more input devices, a first gesture performed by a first hand; and in response to detecting the first gesture: in accordance with a determination that the first gesture satisfies a first set of criteria, wherein the first set of criteria includes a criterion that is satisfied when the first gesture includes the first hand being in a first position that is at least a threshold distance from a first body part of a user, performing an audio playback adjustment operation; and in accordance with a determination that the first gesture does not satisfy the first set of criteria, forgoing performing the audio playback adjustment operation.

In accordance with some embodiments, a non-transitory computer-readable storage medium is described. The non-transitory computer-readable storage medium stores one or more programs configured to be executed by one or more processors of a computer system having one or more input devices, the one or more programs including instructions for: detecting, via the one or more input devices, a first gesture performed by a first hand; and in response to detecting the first gesture: in accordance with a determination that the first gesture satisfies a first set of criteria, wherein the first set of criteria includes a criterion that is satisfied when the first gesture includes the first hand being in a first position that is at least a threshold distance from a first body part of a user, performing an audio playback adjustment operation; and in accordance with a determination that the first gesture does not satisfy the first set of criteria, forgoing performing the audio playback adjustment operation.

In accordance with some embodiments, a transitory computer-readable storage medium is described. The transitory computer-readable storage medium stores one or more programs configured to be executed by one or more processors of a computer system having one or more input devices, the one or more programs including instructions for: detecting, via the one or more input devices, a first gesture performed by a first hand; and in response to detecting the first gesture: in accordance with a determination that the first gesture satisfies a first set of criteria, wherein the first set of criteria includes a criterion that is satisfied when the first gesture includes the first hand being in a first position that is at least a threshold distance from a first body part of a user, performing an audio playback adjustment operation; and in accordance with a determination that the first gesture does not satisfy the first set of criteria, forgoing performing the audio playback adjustment operation.

In accordance with some embodiments, a computer system having one or more input devices, comprising: one or more processors; and memory storing one or more programs configured to be executed by the one or more processors is described. The one or more programs include instructions for: detecting, via the one or more input devices, a first gesture performed by a first hand; and in response to detecting the first gesture: in accordance with a determination that the first gesture satisfies a first set of criteria, wherein the first set of criteria includes a criterion that is satisfied when the first gesture includes the first hand being in a first position that is at least a threshold distance from a first body part of a user, performing an audio playback adjustment operation; and in accordance with a determination that the first gesture does not satisfy the first set of criteria, forgoing performing the audio playback adjustment operation.

In accordance with some embodiments, a computer system having one or more input devices is described. The computer system comprises: means for, detecting, via the one or more input devices, a first gesture performed by a first hand; and means, responsive to detecting the first gesture, for: according to a determination that the first gesture satisfies a first set of criteria, wherein the first set of criteria includes a criterion that is satisfied when the first gesture includes the first hand being in a first position that is at least a threshold distance from a first body part of a user, for performing an audio playback adjustment operation; and according to a determination that the first gesture does not satisfy the first set of criteria, for forgoing performing the audio playback adjustment operation.

In accordance with some embodiments, a computer program product, comprising one or more programs configured to be executed by one or more processors of a computer system having one or more input devices is described. The one or more programs include instructions for: detecting, via the one or more input devices, a first gesture performed by a first hand; and in response to detecting the first gesture: in accordance with a determination that the first gesture satisfies a first set of criteria, wherein the first set of criteria includes a criterion that is satisfied when the first gesture includes the first hand being in a first position that is at least a threshold distance from a first body part of a user, performing an audio playback adjustment operation; and in accordance with a determination that the first gesture does not satisfy the first set of criteria, forgoing performing the audio playback adjustment operation.

In accordance with some embodiments, a method, performed at a computer system having a display generation component and one or more input devices is described. The method includes: at a computer system that is in communication with a display generation component and one or more input devices: while displaying, via the display generation component, a user interface that includes a virtual object, detecting, via the one or more input devices, an input; and in response to detecting the input: in accordance with a determination that attention of the user was directed to a first virtual object in conjunction with detecting the input and that the input corresponds to a first type of input, performing a first operation with respect to the first virtual object; in accordance with a determination that attention of the user was directed to the first virtual object in conjunction with detecting the input and that the input corresponds to a second type of input that is different from the first type of input, performing a second operation with respect to the first virtual object, wherein the second operation is different from the first operation; in accordance with a determination that attention of the user was directed to a second virtual object in conjunction with detecting the input, wherein the second virtual object is different from the first virtual object, and that the input corresponds to the first type of input, performing the first operation with respect to the second virtual object; and in accordance with a determination that attention of the user was directed to the second virtual object in conjunction with detecting the input and that the input corresponds to the second type of input, performing the first operation with respect to the second virtual object.

In accordance with some embodiments, a non-transitory computer-readable storage medium is described. The non-transitory computer-readable storage medium stores one or more programs configured to be executed by one or more processors of a computer system having a display generation component and one or more input devices, the one or more programs including instructions for: while displaying, via the display generation component, a user interface that includes a virtual object, detecting, via the one or more input devices, an input; and in response to detecting the input: in accordance with a determination that attention of the user was directed to a first virtual object in conjunction with detecting the input and that the input corresponds to a first type of input, performing a first operation with respect to the first virtual object; in accordance with a determination that attention of the user was directed to the first virtual object in conjunction with detecting the input and that the input corresponds to a second type of input that is different from the first type of input, performing a second operation with respect to the first virtual object, wherein the second operation is different from the first operation; in accordance with a determination that attention of the user was directed to a second virtual object in conjunction with detecting the input, wherein the second virtual object is different from the first virtual object, and that the input corresponds to the first type of input, performing the first operation with respect to the second virtual object; and in accordance with a determination that attention of the user was directed to the second virtual object in conjunction with detecting the input and that the input corresponds to the second type of input, performing the first operation with respect to the second virtual object.

In accordance with some embodiments, a transitory computer-readable storage medium is described. The transitory computer-readable storage medium stores one or more programs configured to be executed by one or more processors of a computer system having a display generation component and one or more input devices, the one or more programs including instructions for: while displaying, via the display generation component, a user interface that includes a virtual object, detecting, via the one or more input devices, an input; and in response to detecting the input: in accordance with a determination that attention of the user was directed to a first virtual object in conjunction with detecting the input and that the input corresponds to a first type of input, performing a first operation with respect to the first virtual object; in accordance with a determination that attention of the user was directed to the first virtual object in conjunction with detecting the input and that the input corresponds to a second type of input that is different from the first type of input, performing a second operation with respect to the first virtual object, wherein the second operation is different from the first operation; in accordance with a determination that attention of the user was directed to a second virtual object in conjunction with detecting the input, wherein the second virtual object is different from the first virtual object, and that the input corresponds to the first type of input, performing the first operation with respect to the second virtual object; and in accordance with a determination that attention of the user was directed to the second virtual object in conjunction with detecting the input and that the input corresponds to the second type of input, performing the first operation with respect to the second virtual object.

In accordance with some embodiments, a computer system having a display generation component and one or more input devices, comprising: one or more processors; and memory storing one or more programs configured to be executed by the one or more processors is described. The one or more programs include instructions for: while displaying, via the display generation component, a user interface that includes a virtual object, detecting, via the one or more input devices, an input; and in response to detecting the input: in accordance with a determination that attention of the user was directed to a first virtual object in conjunction with detecting the input and that the input corresponds to a first type of input, performing a first operation with respect to the first virtual object; in accordance with a determination that attention of the user was directed to the first virtual object in conjunction with detecting the input and that the input corresponds to a second type of input that is different from the first type of input, performing a second operation with respect to the first virtual object, wherein the second operation is different from the first operation; in accordance with a determination that attention of the user was directed to a second virtual object in conjunction with detecting the input, wherein the second virtual object is different from the first virtual object, and that the input corresponds to the first type of input, performing the first operation with respect to the second virtual object; and in accordance with a determination that attention of the user was directed to the second virtual object in conjunction with detecting the input and that the input corresponds to the second type of input, performing the first operation with respect to the second virtual object.

In accordance with some embodiments, a computer system having a display generation component and one or more input devices is described. The computer system comprises: means, while displaying, via the display generation component, a user interface that includes a virtual object, for detecting, via the one or more input devices, an input; and means, responsive to detecting the input, for: according to a determination that attention of the user was directed to a first virtual object in conjunction with detecting the input and that the input corresponds to a first type of input, for performing a first operation with respect to the first virtual object; according to a determination that attention of the user was directed to the first virtual object in conjunction with detecting the input and that the input corresponds to a second type of input that is different from the first type of input, for performing a second operation with respect to the first virtual object, wherein the second operation is different from the first operation; according to a determination that attention of the user was directed to a second virtual object in conjunction with detecting the input, wherein the second virtual object is different from the first virtual object, and that the input corresponds to the first type of input, for performing the first operation with respect to the second virtual object; and according to a determination that attention of the user was directed to the second virtual object in conjunction with detecting the input and that the input corresponds to the second type of input, for performing the first operation with respect to the second virtual object.

In accordance with some embodiments, a computer program product, comprising one or more programs configured to be executed by one or more processors of a computer system having a display generation component and one or more input devices is described. The one or more programs include instructions for: while displaying, via the display generation component, a user interface that includes a virtual object, detecting, via the one or more input devices, an input; and in response to detecting the input: in accordance with a determination that attention of the user was directed to a first virtual object in conjunction with detecting the input and that the input corresponds to a first type of input, performing a first operation with respect to the first virtual object; in accordance with a determination that attention of the user was directed to the first virtual object in conjunction with detecting the input and that the input corresponds to a second type of input that is different from the first type of input, performing a second operation with respect to the first virtual object, wherein the second operation is different from the first operation; in accordance with a determination that attention of the user was directed to a second virtual object in conjunction with detecting the input, wherein the second virtual object is different from the first virtual object, and that the input corresponds to the first type of input, performing the first operation with respect to the second virtual object; and in accordance with a determination that attention of the user was directed to the second virtual object in conjunction with detecting the input and that the input corresponds to the second type of input, performing the first operation with respect to the second virtual object.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7E illustrate example techniques for performing operations using air gestures, in accordance with some embodiments.

FIG. 8 is a flow diagram of methods of performing operations using air gestures, in accordance with various embodiments.

FIGS. 9A-9D illustrate example techniques for audio playback adjustment using gestures, in accordance with some embodiments.

FIG. 10 is a flow diagram of methods of audio playback adjustment using gestures, in accordance with various embodiments.

FIGS. 11A-11H illustrate example techniques for conditionally responding to inputs, in accordance with some embodiments.

FIG. 12 is a flow diagram of methods of conditionally responding to inputs, in accordance with various embodiments.

### DESCRIPTION OF EMBODIMENTS

The present disclosure relates to user interfaces for providing an extended reality (XR) experience to a user, in accordance with some embodiments.

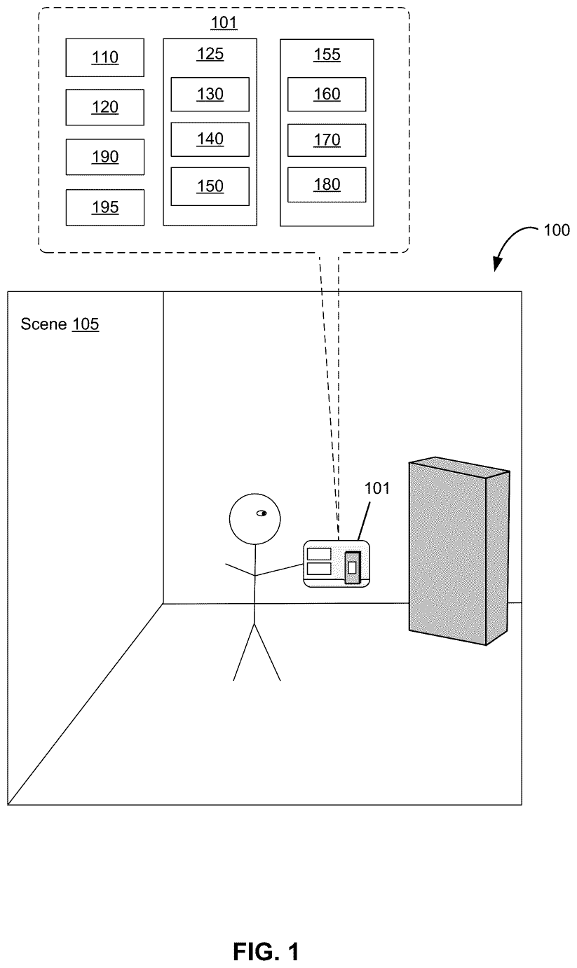

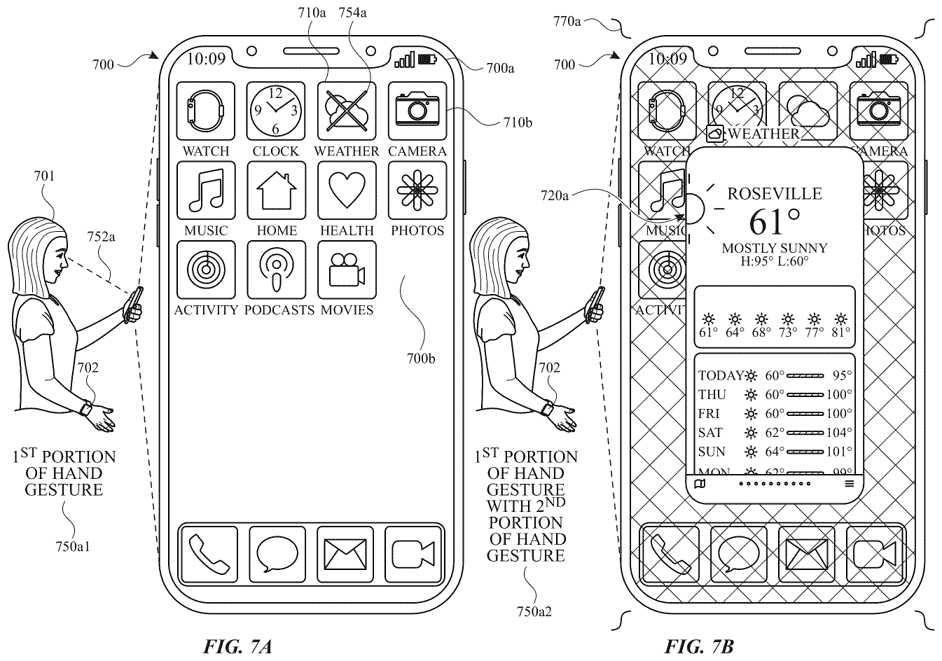

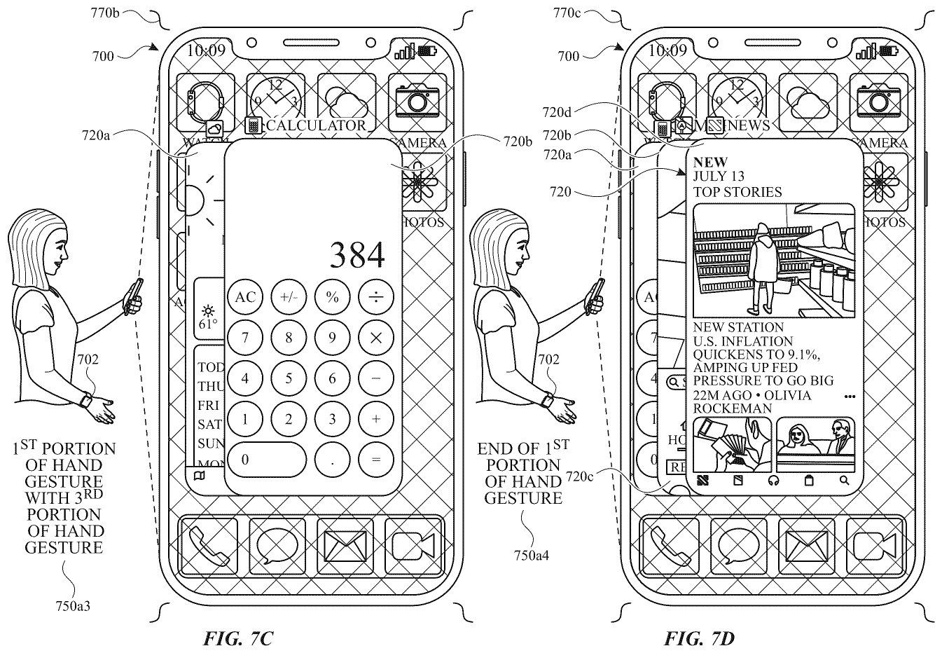

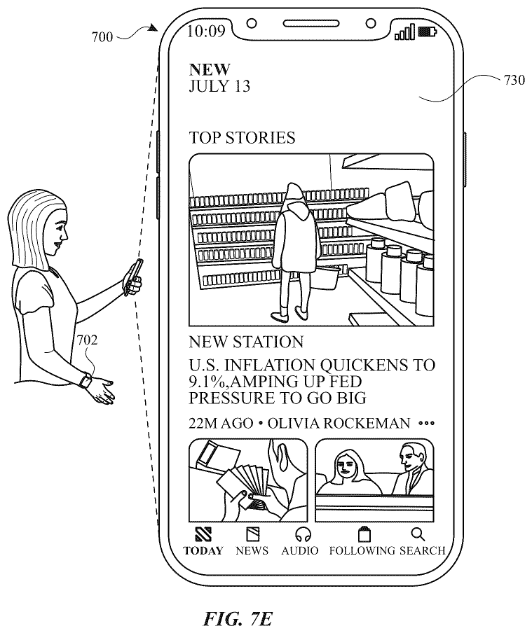

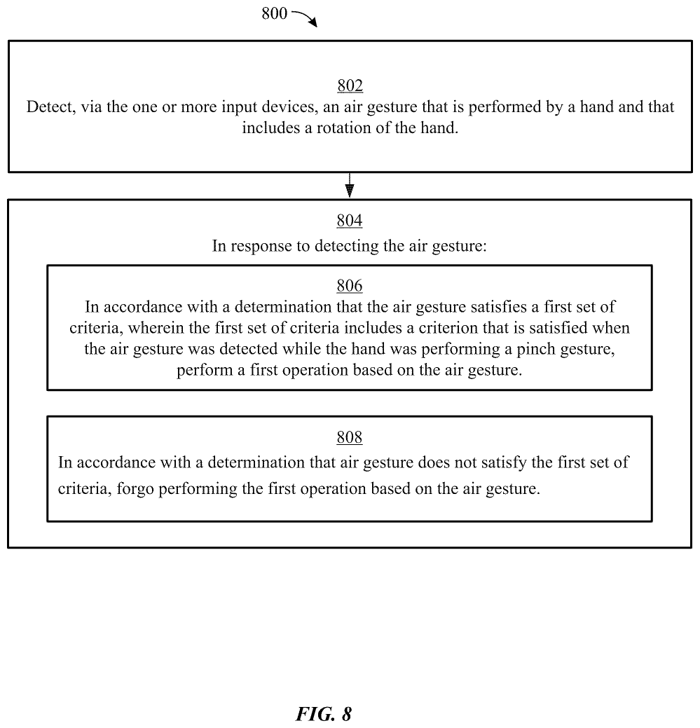

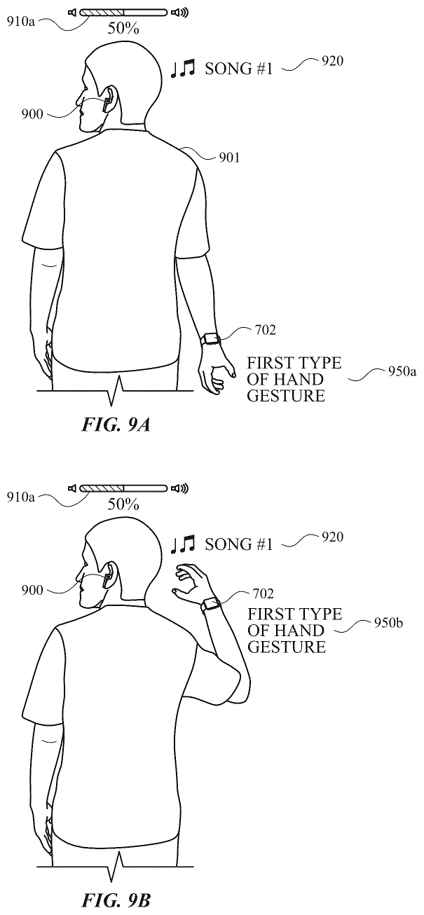

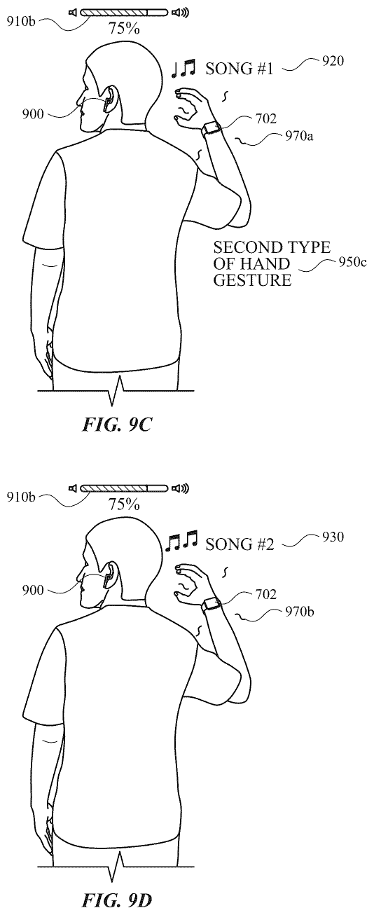

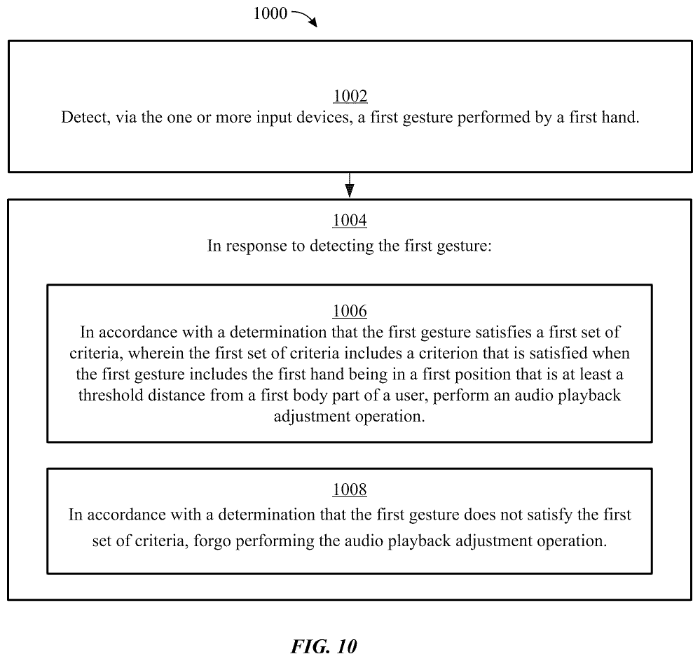

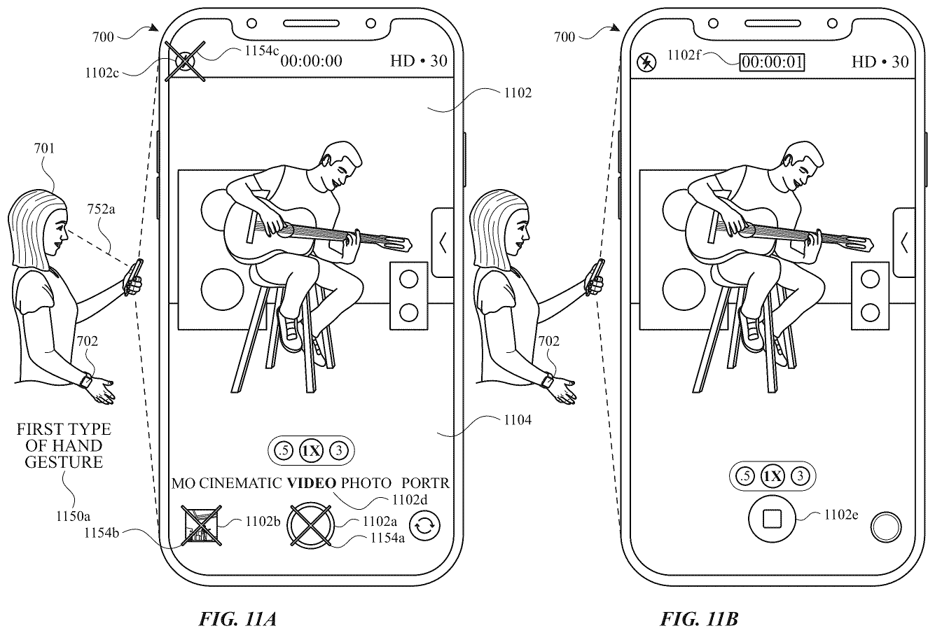

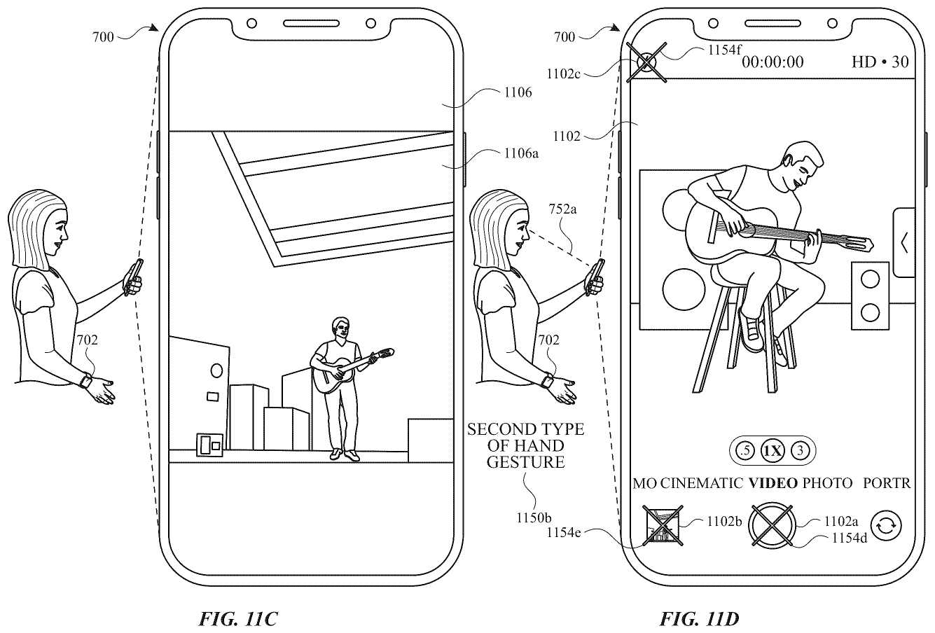

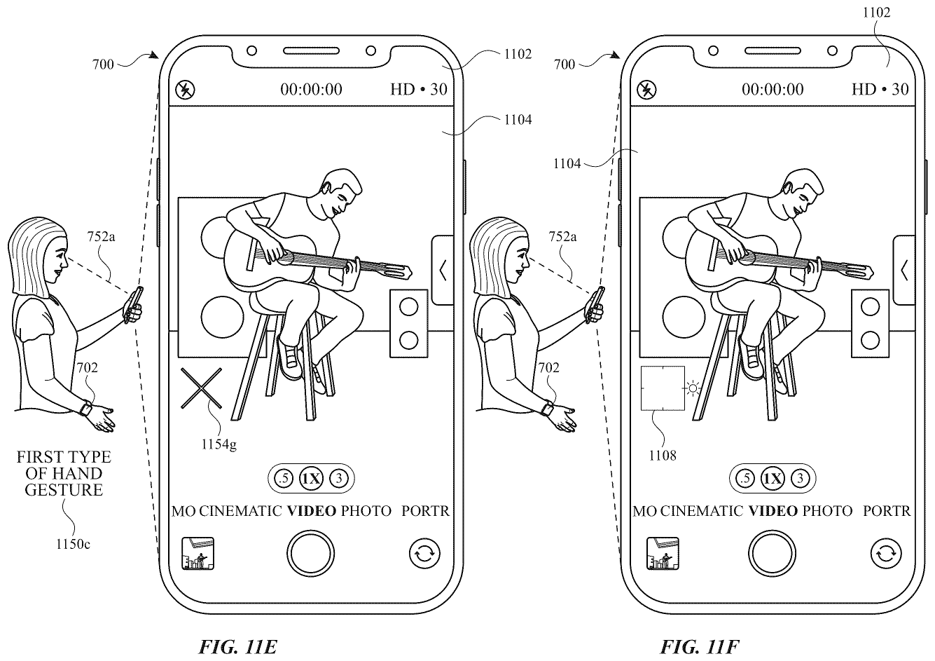

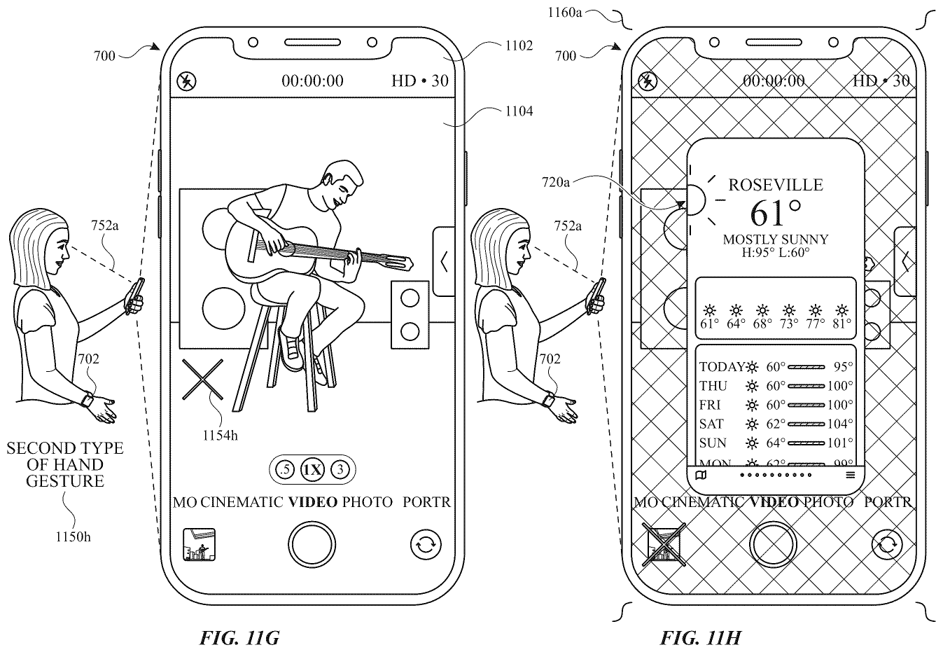

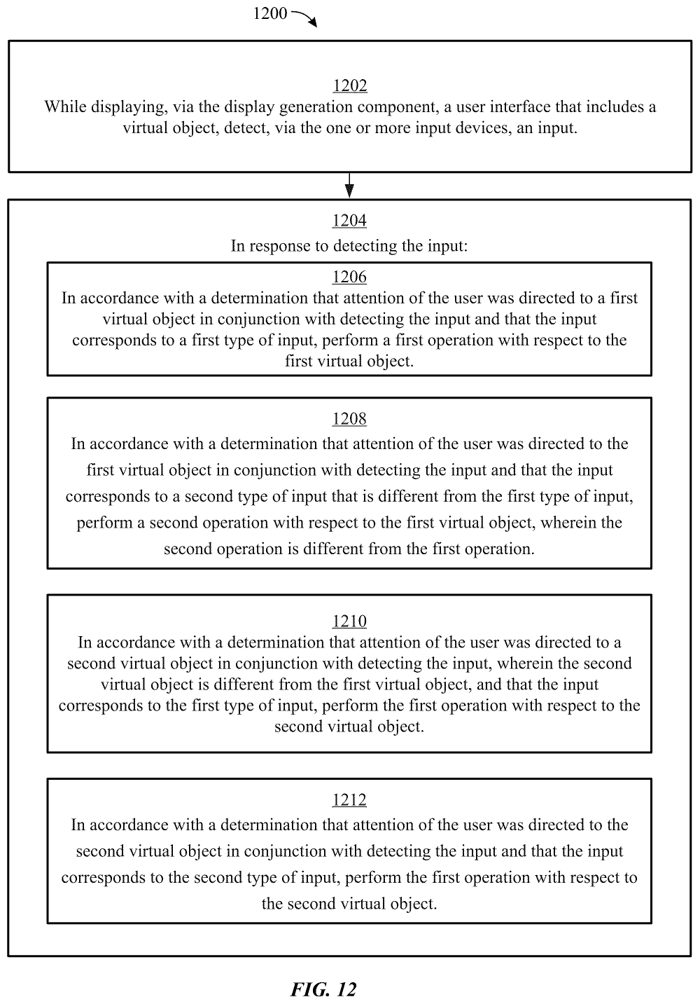

FIGS. 1-6 provide a description of example computer systems for providing XR experiences to users. FIGS. 7A-7E illustrate example techniques for performing operations using air gestures, in accordance with some embodiments. FIG. 8 is a flow diagram of methods of performing operations using air gestures, in accordance with various embodiments. The user interfaces in FIGS. 7A-7E are used to illustrate the processes in FIG. 8. FIGS. 9A-9D illustrate example techniques for audio playback adjustment using gestures, in accordance with some embodiments. FIG. 10 is a flow diagram of methods of for audio playback adjustment using gestures, in accordance with various embodiments. The diagrams in FIGS. 9A-9D are used to illustrate the processes in FIG. 10. FIGS. 11A-11H illustrate example techniques for conditionally responding to inputs, in accordance with some embodiments. FIG. 12 is a flow diagram of methods of for conditionally responding to inputs, in accordance with various embodiments. The user interfaces in FIGS. 11A-11H are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

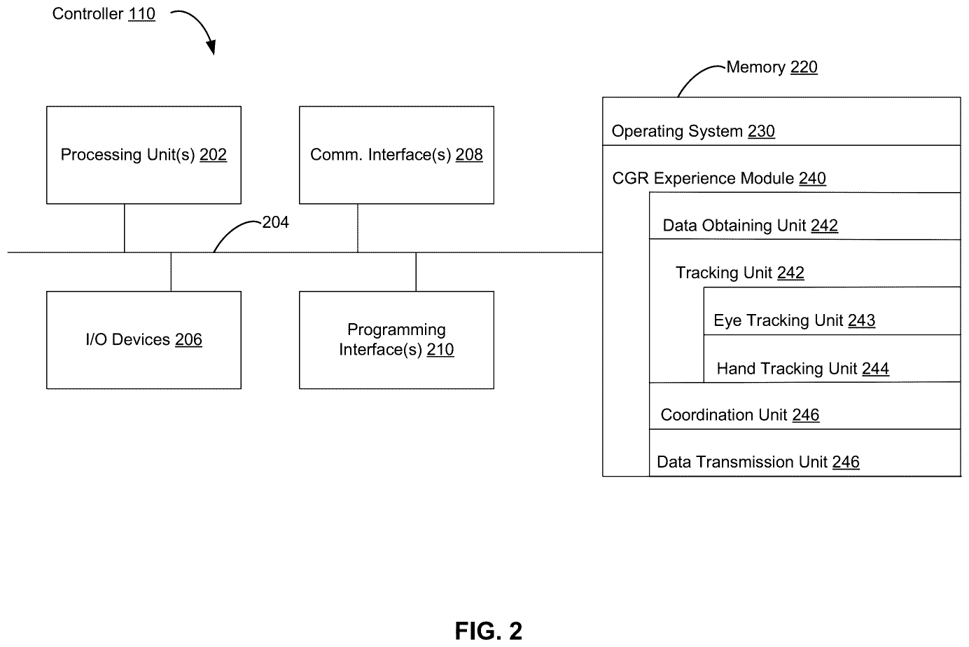

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

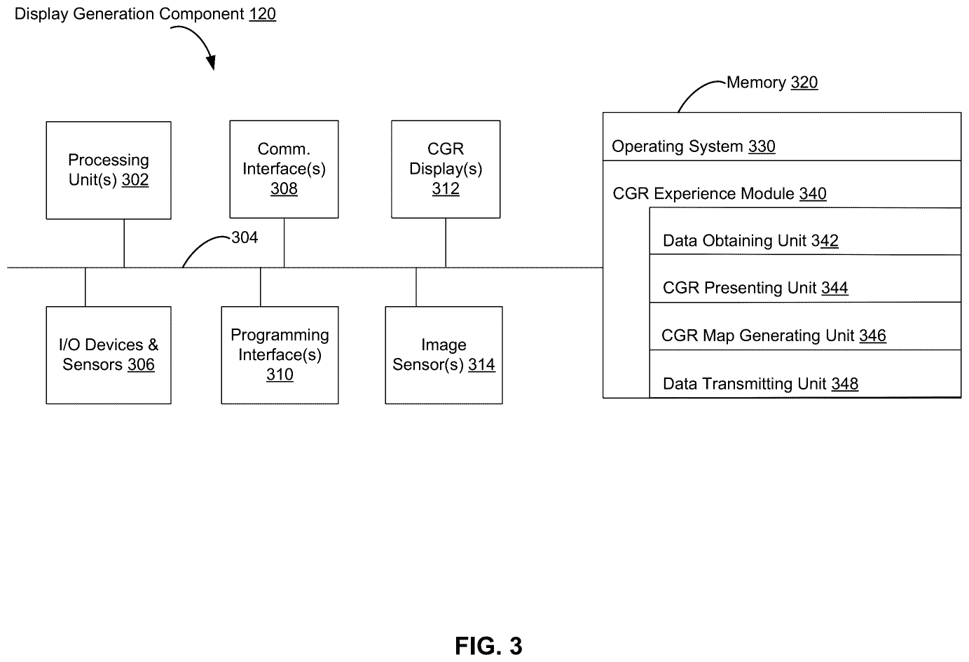

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

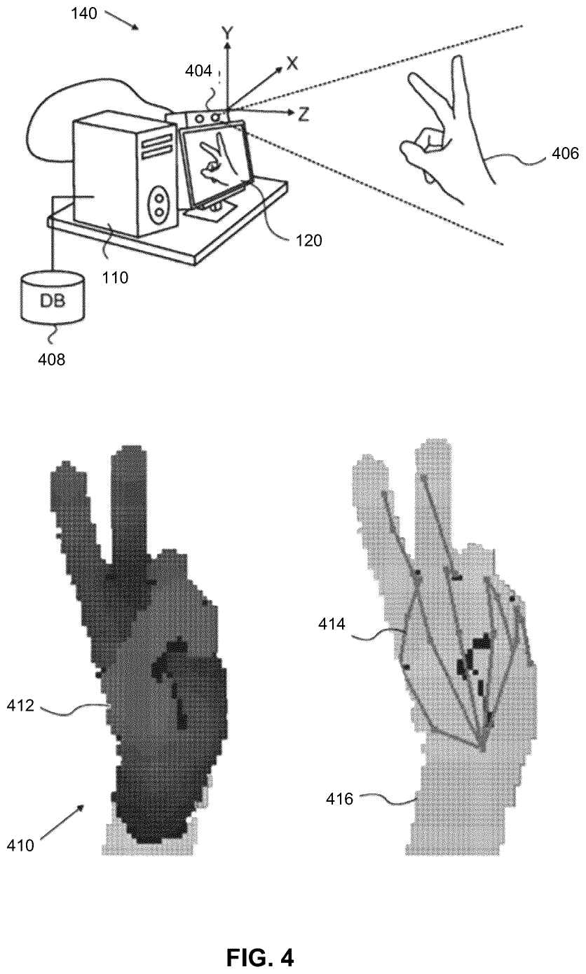

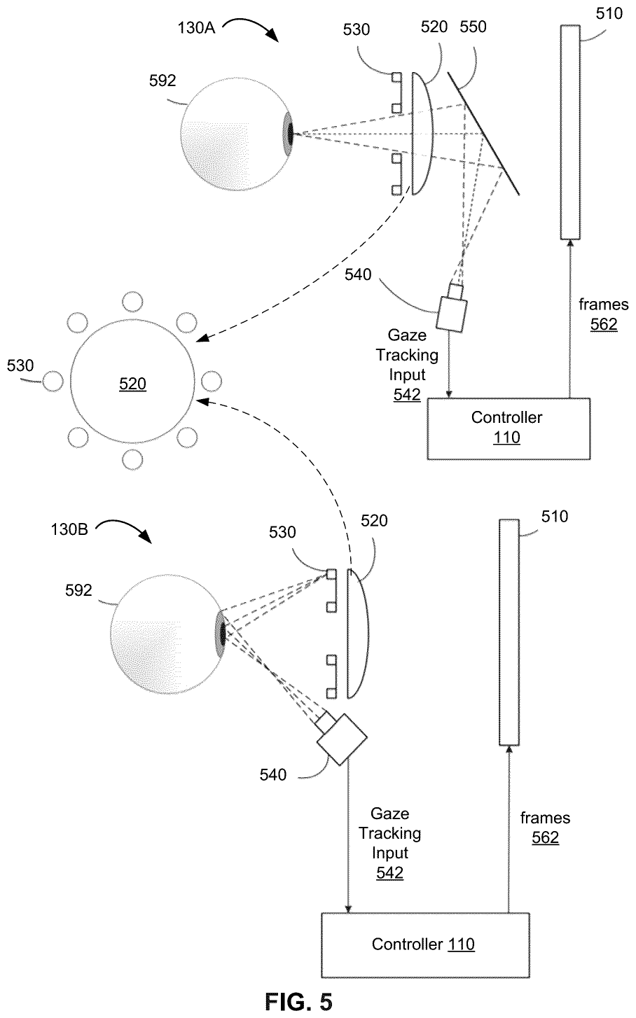

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

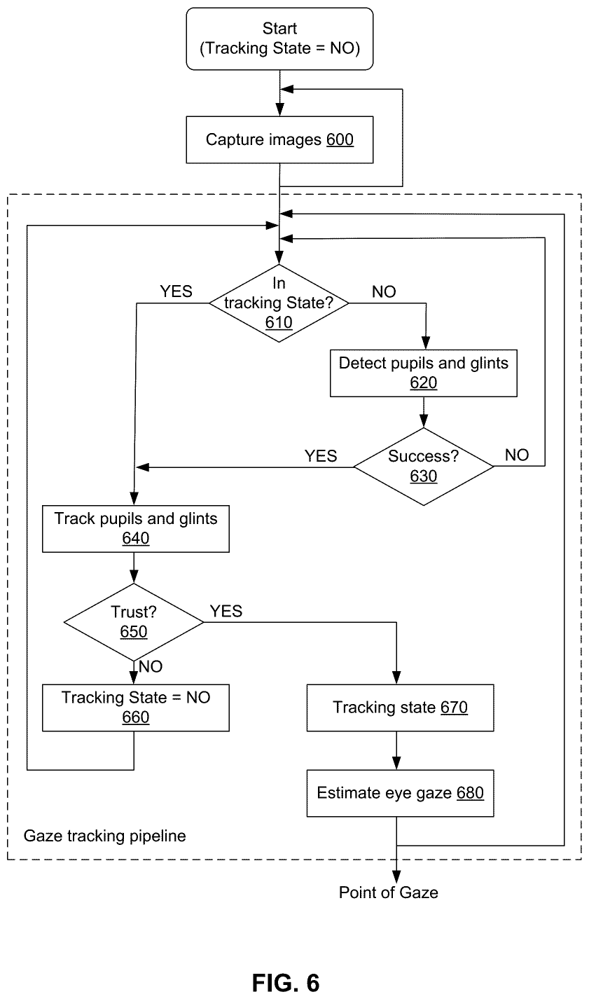

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

User Interfaces and Associated Processes

Attention is now directed towards embodiments of user interfaces (“UI”) and associated processes that may be implemented on a computer system, such as a portable multifunction device (e.g., a smart phone) or a head-mounted device, in communication with one or more input devices and (optionally) a display generation component.

FIGS. 7A-7E illustrate examples of techniques for performing operations using air gestures. FIG. 8 is a flow diagram of an exemplary method 800 for performing operations using air gestures. The user interfaces in FIGS. 7A-7E are used to illustrate the processes described below, including the processes in FIG. 8.

In FIG. 7A, user 701 is holding and interacting with device 700 that includes display 700a that, in FIG. 7A, is displaying home screen interface 700b. In some embodiments, device 700 includes one or more features of computer system 101, such as eye tracking device 130.

FIG. 7A also illustrates user 701 wearing wearable device 702. Wearable device 702 is on the right hand of user 701. In some embodiments, wearable device 702 includes one or more sensors (e.g., one or more heart rate and/or blood pressure sensors (e.g., one or more light-emitting elements and/or optical sensors on the back side of the device that is oriented towards the wrist of user 701), accelerometers and/or gyroscopes) that detect the movement (e.g., rotation and/or lateral movement), orientation, gestures, and positioning of the right hand of user 701. At FIG. 7A, the right hand of user 701 is in a neutral position (e.g., the right hand of user 702 is not rotated) and is unclenched. In the embodiment of FIGS. 7A-7E, wearable device 702 is a smartwatch. However, in some embodiments, wearable device 702 is another device that is capable of being worn (e.g., a bracelet, a ring, a brooch, or a pin) and capable of tracking hand movement (e.g., via a camera or other optical sensor, or a motion sensor). In some embodiments, device 702 includes one or more components of computer system 101. In some embodiments, device 700 also include one or more sensors (e.g., a camera or other optical sensor, or a motion sensor) that is capable of tracking hand movements and gestures of the user.

Returning to device 700 in FIG. 7A, home screen user interface 700b includes a number of application icons, including weather application icon 710a that corresponds to a weather application and camera application icon 710b that corresponds to a camera application. In some embodiments, display 700a is touch-sensitive and device 700, upon detecting a touch contact on an application icon, opens and/or launches a corresponding application. In FIG. 7A, device 700 detects (e.g., via eye tracking device 130) that the gaze of user 701 is directed to weather application icon 710a, as indicated by illustrative gaze line 752a and gaze target indication 754a. In the embodiment of FIGS. 7A-7E, gaze line 752a and gaze target indication 754a are provided for illustrative purposes only and are not part of the user interfaces provided by devices 700 and/or 702. In some embodiments, device 700 displays a visual indication (e.g., a position dot) of a detected gaze location/direction. In some embodiments, the attention of the user is determined based on a parameter other than gaze (e.g., the direction a user is pointing with a finger; the position of a cursor controlled by a mouse and/or a joystick).

In some embodiments, home screen interface 700b is part of an extended reality environment displayed via display 700a (e.g., home screen interface 700b is a set of viewpoint-locked virtual objects) that includes a representation of the physical environment (e.g., a passthrough representation based on data captured via one or more cameras of device 700). In some embodiments, device 702 is represented in the extended reality environment. In some embodiments, device 702 is not represented in the extended reality environment, even when it is within a portion of the physical environment that is currently being represented. In some embodiments, device 700 is a head-mounted system or display (e.g., an HMD) and device 700 and/or device 702 detects various hand gestures performed by user 701 while operating device 700 that is an HMD. In such embodiments, user 701 can control certain operations of devices 700 and/or 702 via hand gestures, without having to make contact (e.g., provide touch inputs) to device 700 and/or device 702. Control via hand gestures can be especially useful for an HMD as hardware elements (e.g., buttons or touch-sensitive surfaces) of the HMD may not be visible to the user while wearing the HMD and/or may be difficult to operate due to their position and/or lack of visibility.

At FIG. 7A, device 702 (in some embodiments, and/or device 700) detects a first input that is a first portion of a hand gesture, as indicated by illustrative text 750a1. In some embodiments, the detected first portion of the hand gesture is a pinch air gesture made using the thumb and forefinger of the right hand of user 701, without the fingers contact device 700 or 702. In some embodiments, the air gesture is a different air gesture, such as a tapping gesture made with the forefinger or middle finger (e.g., a mid-air tap that does not involve contacting either device 700 or device 702 with the user's fingers) or positioning the user's fingers in a predetermined pose (e.g., a “C” shape made with the thumb and forefinger). In some embodiments, the detected input is not an air gesture, such as a device 700 and/or device 702 detecting contact with, or actuation of, a hardware button. While this description refers to the first input as a first portion of a hand gesture, it should be understood that the first input can also be referred to and considered as a discrete hand gesture (e.g., rather than as a portion of hand gesture that can include other portions), as well.

At FIG. 7B, in response to detecting the first input that is the first portion of the hand gesture that corresponds to text 750a1, device 702 transmits an indication of the detected first input to device 700. Device 700, in response to receiving the indication of the detected first input, displays representation 720a that corresponds to a weather application and outputs haptic output 770a. In some embodiments, haptic output 770a is provided by device 702 or both devices 700 and 702 provide haptic outputs. In some embodiments, representation 720a is a preview of the weather application and can be selected (e.g., via touch, via gaze and/or an air gesture) to display a user interface of the weather application. In some embodiments, representation 720a is a user interface of the weather application, with which the user can directly interact (e.g., to select different locations for corresponding weather information). As noted with reference to FIG. 7A, device 700 detected that the gaze of user 701 was directed to weather application icon 710a at the time that the first input was detected. In some embodiments, device 700 displays representation 720a in response to the first input because device 700 detected that gaze of the user was directed to weather application icon 710a and had the gaze of the user been directed to a different application icon (e.g., camera application icon 710b) a different representation of a different application (e.g., a representation of the camera application) would have been displayed, instead. In some embodiments, device 700 displays representation 720a regardless of the detected direction of the user's gaze (e.g., because the weather application was a last opened application and/or because the weather application is a designated and/or favorited application). In some embodiments, device 700, in response to receiving the indication of the first input, does not display representation 720a when the gaze of the user is positioned on an object (e.g., a graphical indication of time) that is not associated with performing an operation when the first input is detected.

At FIG. 7B, device 702 detects a second input that is the first portion of the hand gesture (e.g., maintenance of the first input (e.g., the user continuing to maintain a pinch air gesture)) in combination with a second portion of the hand gesture, as indicated by illustrative text 750a2. In some embodiments, the second portion of the hand gesture is an air gesture that includes rotation of the hand of user 701 that is performed while maintaining the first portion of the hand gesture (e.g., the user rotates her hand while continuing to pinch). In some embodiments, device 702 detects that the hand rotation of the second input occurs at a first speed (e.g., 10 degrees per second) and includes rotation of the hand by a first angular distance (e.g., 20 degrees), which is determined to correspond to a request to transition to display of a next application representation (e.g., the second input is determined to be a request for a transition magnitude of one). In some embodiments, detecting the second input includes detecting an air gesture similar to the position and movement of a user's hand when turning a physical knob and/or dial (e.g., a pinching motion followed by rotation). While this description refers to the second input as a second portion of a hand gesture that also included the first portion of FIG. 7A, it should be understood that the second input can also be referred to and considered as a discrete hand gesture (e.g., rather than as a portion of hand gesture that also includes other portions (e.g., the first portion), as well.

AT. FIG. 7C, in response to detecting the second input, device 702 transmits an indication of the detected second input to device 700. Device 700, in response to receiving the indication of the detected second input, displays an animation of representation 720a moving to the left and back to be replaced in the middle foreground of display 700a by representation 720b that corresponds to a calculator application. Device 700 also, in response to receiving the indication of the detected second input, provides haptic output 770b. In some embodiments, one or more properties of haptic output 770b (e.g., duration, amplitude, pattern, and/or frequency) are based on one or more characteristics of the second input (e.g., the speed of rotation, angular distance, and/or resting position of the hand at the end of the rotation) and/or the current operation. For example, in some embodiments, a discrete haptic output (e.g., a discretely perceptible vibration) is outputted as each representation (e.g., representation 720b) transitions onto the display. In some embodiments, haptic output 770b is provided by device 702 or both devices 700 and 702 provide haptic outputs. In some embodiments, detecting the second portion of the hand gesture (e.g., rotation of the hand) without detecting the first portion of the hand gesture (e.g., the pinch gesture) does not cause display of representation 720a (e.g., a first operation). In some embodiments, doing so does not cause any perceptible operation (e.g., rotation of the hand alone is not a mapped gesture).

At FIG. 7C, device 702 detects a third input that is the first portion of the hand gesture (e.g., maintenance of the first input (e.g., the user continuing to maintain a pinch air gesture)) in combination with a third portion of the hand gesture, as indicated by illustrative text 750a3. In some embodiments, the third portion of the hand gesture is an air gesture that includes further rotation of the hand of user 701 in the same direction (e.g., rotating further clockwise beyond a clockwise rotation discussed with respect to FIG. 7B) that is performed while maintaining the first portion of the hand gesture (e.g., the user further rotates her hand while continuing to pinch). In some embodiments, device 702 detects that the hand rotation of the third input occurs at a higher second speed (e.g., 20 degrees per second) and includes rotation of the hand by the same first angular distance (e.g., 20 degrees) as detected in FIG. 7B (e.g., the further rotation is the same amount of rotation as in FIG. 7B, but occurs at a faster speed), which is determined to correspond to a request to transition to display of an application representation that is two representations away from representation 720b in a sequence of representations (e.g., the second input is determined to be a request for a transition magnitude of two). Thus, in such embodiments, the magnitude of performance of an operation for a respective change in angular distance varies depending on the speed at which the hand was rotated, with the same amount of rotation causing a greater magnitude of performance, when that same amount of rotation is performed at a faster speed. In some embodiments, the third portion of the hand gesture is maintaining the first portion of the hand gesture (e.g., the pinch air gesture) and maintaining the second portion of the hand gesture (e.g., maintaining the hand in the same rotated position of the second portion of the hand gesture, without further rotation); in such embodiments, maintaining the second portion of the hand gesture causes an operation (e.g., transitioning through the representations) to continue as long as the hand gesture continues to be maintained (e.g., similar to the operation of a physical jog-type dial). In some such embodiments, while the operation is being continued based on detecting that the first and second portions of the gesture are maintained, detecting a rotation in the opposite direction of the rotation of the second portion (e.g., the second portion was clockwise, detecting a counterclockwise rotation) causes the operation to cease (e.g., to no longer be continued). In some such embodiments, while the operation is being continued based on detecting that the first and second portions of the gesture are maintained, detecting a further rotation of the hand in the same direction as the second portion (e.g., the second portion was clockwise, detecting a further clockwise rotation) causes a speed of the operation (e.g., a speed at which representations (e.g., 720a-d) are transitioned) to increase.

In some embodiments, the third portion of the hand gesture is rotation in the opposite direction of the direction of the hand gesture in FIG. 7B; in such embodiments, representation 720a would transition back to being in the middle foreground of display 700a (e.g., the operation has a direction component that is determined based on the direction of rotation). While this description refers to the third input as a third portion of a hand gesture that also included the first portion of FIG. 7A and the second portion of FIG. 7B, it should be understood that the third input can also be referred to and considered as a discrete hand gesture (e.g., rather than as a portion of hand gesture that also includes other portions (e.g., the first portion)), as well.

AT. FIG. 7D, in response to detecting the third input, device 702 transmits an indication of the detected third input to device 700. Device 700, in response to receiving the indication of the detected third input, displays an animation of representation 720b moving to the left and back and of application representation 720c that corresponds to a map application and representation 720d transitioning on to display 700a. Representation 720c is a representation that comes after representation 720b in a series of representations with representation 720d being the representation after representation 720c (e.g., representation 720d is two places after representation 720b in the series). Representation 720d is at the middle foreground of display 700a. In some embodiments, device 700 transitioned two representations in the series (e.g., rather than one as occurred in FIG. 7C) in response to the third input because the third input included a further hand rotation that rotated the same first angular distance, though at a higher second speed (e.g., as compared to the first speed of the hand rotation of the second input). Device 700 also, in response to receiving the indication of the detected third input, provides haptic output 770c. In some embodiments, a component of the adjustment is based on a characteristic of the input. For example, in some embodiments, when the second input includes rotation of the user's hand, the direction of the adjustment is determined based on a direction of the rotation (e.g., clockwise for an increase in volume and counter-clockwise for a decrease in volume); further, a magnitude of the adjustment is based on the speed and/or angular distance of the rotation (e.g., each degree of change in angular distance results in a 1% increase or decrease in the volume). In some embodiments, haptic output 770c is provided by device 702 or both devices 700 and 702 provide haptic outputs.

At FIG. 7D, device 702 detects a fourth input that includes an end to the first portion of the hand gesture (e.g., the user moves her thumb and forefinger apart (e.g., by relaxing her hand), thereby ceasing to maintain the pinch gesture), as indicated by text 750a4. In some embodiments, the fourth input does not include any rotation of the hand of user 701.

At FIG. 7E, in response to detecting the fourth input, device 702 transmits an indication of the detected fourth input to device 700. Device 700, in response to receiving the indication of the detected fourth input, displays user interface 730 of the news application (e.g., exists the representation selection mode). Thus, in the embodiment of FIGS. 7A-7E, user 701 is able to initiate a selection operation (e.g., via the first input), navigate through a series of application representations (e.g., via the second and third inputs) to an application of interest, and then open the application of interest (e.g., via the fourth input), all via gestures performed by one hand, without contacting either device 700 or device 702 with the hand. In some embodiments, rather than displaying user interface 730, device 700, in response to detecting the fourth input, ceases further transitions of the representations of applications (e.g., exits a mode where the representations transition) but continues to display the same content (e.g., as seen in FIG. 7D).

Additional descriptions regarding FIGS. 7A-7E are provided below in reference to method 800 described with respect to FIGS. 7A-7E.

FIG. 8 is a flow diagram of an exemplary method 800 for performing operations using air gestures, in accordance with some embodiments. In some embodiments, method 800 is performed at a computer system (e.g., e.g., a smartphone, a desktop computer, a laptop, a tablet, a smart watch, a wrist-worn fitness tracker, a heads-up display unit, a head-mounted display unit, an optical head-mounted display unit, a head mounted augmented reality and/or extended reality device, and/or a wearable device) (in some embodiments, computer system 101 in FIG. 1, device 700, device 702, and/or device 900) that is in communication with one or more input devices (e.g., a camera, a gyroscope, an accelerometer, an acoustic sensor, and/or a physiological sensor (e.g., a blood pressure sensor and/or a heart rate sensor); hand tracking unit 244 and/or eye tracking unit 243). In some embodiments, the one or more input devices are integrated into an external device (e.g., a smartwatch and/or a wearable device; device 702) that is in communication with the computer system. In some embodiments, the computer system is in communication with a display generation component (e.g., display 700a, a display controller, a touch-sensitive display system, and/or a head mounted display system). In some embodiments, method 800 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 800 are, optionally, combined and/or the order of some operations is, optionally, changed.

The computer system (e.g., 700, 702, and/or 900) detects (802), via the one or more input devices (e.g., 244, an air gesture (and, in some embodiments, a gesture made with the hand that does not include direct contact with the computer system and/or one or more sensors of the computer system)) that is performed by a hand (e.g., a hand of a user of the computer system) and that includes a rotation of the hand (e.g., 750a2 or 750a3) (e.g., rotation in a first direction, rotation at a first speed, rotation at a first acceleration, rotation of the wrist of the user, and/or rotation around an axis that is parallel to the wrist of the user). In some embodiments, the air gesture is detected via one or more physiological and/or optical sensors and/or gyroscopes of an external device (e.g., a smart watch and/or wrist-worn fitness tracker that is in communication with the computer system and that includes one or more physiological sensors).

In response to detecting the air gesture (804) and in accordance with a determination that the air gesture satisfies a first set of criteria, wherein the first set of criteria includes a criterion that is satisfied when the air gesture (and/or, in some embodiments, at least a portion of the air gesture) was detected (e.g., that at least a portion of the air gesture was detected) while (in some embodiments, detecting, via the one or more input devices, that) the hand was performing (and/or is performing) a pinch gesture (e.g., a gesture a finger (e.g., a predetermined finger (e.g., the index finger) and/or a thumb of the hand are with a predetermined distance (e.g., in contact or near contact) of another finger and/or a thumb) (e.g., as seen FIG. 7B and/or FIG. 7D), the computer system performs (806) a first operation (e.g., as display of 720a as seen in FIG. 7B) based on the air gesture (e.g., adjusting a volume, navigating through a list of items, scrolling through content, adjusting one or more characteristics of the computer system (e.g., brightness, contrast, tone, and/or warmth)). In some embodiments, a pinch gesture includes a finger and/or thumb being within a predetermined orientation (e.g., with the pads substantially facing each other) of another finger and/or thumb and/or another portion of the hand).

In response to detecting the air gesture (804) and in accordance with a determination that air gesture does not satisfy the first set of criteria (e.g., because the hand rotation was not being performed while the pinch was being performed), the computer system forgoes (808) performing the first operation based on the air gesture (e.g., as discussed with respect to FIG. 7C) (e.g., forgoing performing any operation based on the air gesture and/or performing an operation different than the first operation). Choosing whether or not to perform a first operation based on the air gesture in response to detecting the air gesture and in accordance with a determination that the air gesture satisfies a first set of criteria, where the first set of criteria includes a criterion that is satisfied when the air gesture was detected the hand was performing a pinch gesture provides more control to the user to cause performance of the first operation by making a particular gesture without requiring additional controls and/or virtual objects that clutter the user interface.

In some embodiments, in response to detecting the air gesture and in accordance with a determination that the air gesture satisfies the first set of criteria and in accordance with a determination that the hand was rotated with a first magnitude (e.g., speed, acceleration, and/or angular distance) of movement (e.g., while the air gesture was being detected), the first operation is performed with a first magnitude of performance (e.g., movement (e.g., lateral movement across the display generation component and/or rotational movement), display speed (e.g., displaying and/or not displaying one or more objects), and/or changing one or more characteristics (e.g., sound, brightness, tone, color, and/or constant) of the display generation component and/or the computer system) (e.g., as described with reference to FIGS. 7C and 7D). In response to detecting the air gesture and in accordance with a determination that the air gesture satisfies the first set of criteria and in accordance with a determination that the hand was rotated with a second magnitude (e.g., speed, acceleration, and/or angular distance) of movement that is different from the first magnitude of movement (e.g., while the air gesture was being detected), the first operation is performed with a second magnitude of performance that is different from the first magnitude of performance (e.g., as described with reference to FIGS. 7C and 7D). In some embodiments, the first operation is performed at a faster rate as the hand is rotated faster and/or the first operation is performed at a slower rate as the hand is rotated slower. Performing the first operation with a magnitude of performance based on the magnitude of movement of the rotation hand is rotated allows the user to control how the first operation is performed, which provides the user with more control over the computer system without cluttering the user interface.

In some embodiments, in response to detecting the air gesture and in accordance with a determination that the air gesture satisfies the first set of criteria and in accordance with a determination that the hand was rotated at a first speed (e.g., current speed, mean speed, median speed, and/or minimum and/or maximum speed while the hand was rotated) and the hand was rotated a first angular distance, the first operation is performed with a third magnitude of performance (e.g., as described with reference to FIGS. 7C and 7D with reference to gesture 750a3). In some embodiments, in response to detecting the air gesture and in accordance with a determination that the air gesture satisfies the first set of criteria and in accordance with a determination that the hand was rotated at the first speed (e.g., current speed, mean speed, median speed, and/or minimum and/or maximum speed while the hand was rotated) and the hand was rotated a second angular distance that is different from the first angular distance, the first operation is performed with a fourth magnitude of performance that is different from the third magnitude of performance (e.g., as described with reference to FIGS. 7C and 7D with reference to gesture 750a3). In some embodiments, performing the first operation with the third magnitude of performance includes moving one or more respective user interface objects by a first amount; and performing the second operation with the fourth magnitude of performance includes moving one or more respective user interface objects by a second amount that is different from the first amount. In some embodiments, the magnitude of performance for a respective change in angular distance varies depending on the speed at which the hand was rotated. In accordance with a determination that the hand was rotated a first angular distance (e.g., 20 degrees) at a first speed (e.g., 10 degrees per second), the first operation is performed with a first magnitude (1 unit) of performance. In accordance with a determination that the hand was rotated for the (same) first angular distance (e.g., 20 degrees) at a second speed (e.g., 20 degrees per second), different from the first speed, the first operation is performed at a second magnitude (e.g., 4 units) that is different from the first magnitude. In some embodiments, the second speed is faster than the first speed and the second magnitude is greater than the first magnitude such that rotating the hand faster, for the same amount of angular distance, causes the operation to be performed with a greater magnitude. Performing the first operation with a magnitude of performance based on the angular distance of the rotation of the hand (and, in some embodiments, even in cases where the hand is rotated at the same speed with different angular distances) allows the user to control how the first operation is performed, which provides the user with more control over the computer system without cluttering the user interface.

In some embodiments, the first angular distance is less than the second angular distance (e.g., as described with reference to FIGS. 7C and 7D with reference to gesture 750a3), and wherein the third magnitude of performance is greater than the fourth magnitude of performance (e.g., faster than and/or the first operation with the third magnitude of performance is performed faster than the first operation with the fourth magnitude of performance because the first angular distance is less than (e.g., smaller than) the second angular distance (and, in some embodiments, irrespective of the speed of the rotation)). Performing the first operation with a magnitude of performance based on the angular distance of the rotation of the hand provides the user to choose to cause the first operation to be performed slower by an increasing the angular distance of the rotation of the hand, which provides the user with more control over the computer system without cluttering the user interface.

In some embodiments, in response to detecting the air gesture and in accordance with a determination that the air gesture satisfies the first set of criteria and in accordance with a determination that the hand was rotated in a first direction (e.g., clockwise direction or counterclockwise direction with respect to yaw, pitch, and/or roll), the first operation is performed based on (e.g., having and/or in a direction that corresponds to the first direction) the first direction (e.g., as described with reference to FIG. 7C and the direction of rotation of 750a3) (e.g., the operation is performed with adjustment in a first adjustment direction such as increasing or decreasing a parameter) (and, in some embodiments, not based on a second direction that is different from the first direction). In some embodiments, in response to detecting the air gesture and in accordance with a determination that the air gesture satisfies the first set of criteria and in accordance with a determination that the hand was rotated in a second direction that is different from (and, in some embodiments, the opposite of) the first direction, the first operation is performed based on the second direction (e.g., the first operation is performed with adjustment in a second adjustment direction such as decreasing or increasing a parameter) (and, in some embodiments, not based on the first direction). In some embodiments, the first operation that is performed based on the first operation is a different operation than the first operation that is performed based on the second direction. Performing the first operation with a direction that is based on the direction of the rotation of the hand allows the user to control how the first operation is performed, which provides the user with more control over the computer system without cluttering the user interface.

In some embodiments, in response to detecting the air gesture and in accordance with a determination that the air gesture satisfies the first set of criteria, the computer system initiates a process for generating a set of one or more haptic outputs (e.g., 770b-c) that indicates that the gesture satisfies the first set of criteria. In some embodiments, in response to detecting the air gesture and in accordance with a determination that the air gesture satisfies the first set of criteria, the computer system generates haptic output and/or the computer system sends instructions that causes the different computer system (e.g., a wearable device, a smartwatch, a wrist worn wearable device, and/or a device that includes the one or more inputs devices that are in communication with the computer system) to generate haptic output. Initiating a process for generating a set of one or more haptic outputs in response to detecting the air gesture and in accordance with a determination that the air gesture satisfies the first set of criteria provides the user with feedback concerning recognition/detection and performance of the first operation, which can also reduce the number of inputs needed to reverse performance of the operation when the user unintentionally causes the first operation.

In some embodiments, the computer system is in communication with a wearable device (e.g., 702) (e.g., a smartwatch, a wrist-worn wearable device, and/or a set of headphones), and initiating the process for generating haptic feedback includes sending one or more instructions that causes the wearable device to generate the set of one or more haptic outputs that indicates that the gesture satisfies the first set of criteria. In some embodiments, a set of one or more haptic outputs are only generated at the wearable device. In some embodiments, the set of one or more haptic outputs are generated at the computer system and the wearable device. In some embodiments, the set of one or more haptic outputs are only generated at the computer system. Sending one or more instructions that causes the wearable device to generate a set of one or more haptic outputs in response to detecting the air gesture and in accordance with a determination that the air gesture satisfies the first set of criteria provides the user with feedback concerning performance of the first operation at the wearable device, which can also reduce the number of inputs needed to reverse performance of the operation when the user unintentionally causes the first operation.

In some embodiments, performing the first operation based on the air gesture includes transitioning (e.g., transitioning between representations 720a-d) (e.g., navigating, changing, and/or displaying) through a first sequence of states (e.g., a list of items, a set of user interface, one or more system states (e.g., on, sleep, and/or off; volume levels; brightness levels; and/or contrast levels)). In some embodiments, while transitioning through the first sequence of states and in accordance with a determination that a first state (e.g., a state, an event, and/or an adjustment event when the first operation adjusts one or more user interface elements and/or one or more settings) in the first sequence of states has been reached, the computer system generates (e.g., issuing, providing, and/or outputting) a set of one or more haptic outputs (e.g., a vibrating buzzing, kinesthetic output) (e.g., at the computer system and/or a computer system (e.g., a wearable device, smart watch, wrist-worn fitness tracker, and/or wrist-worn device)) that is different from the computer system) that indicates the first state in the first sequence of states has been reached. In some embodiments, while transitioning through the first sequence of states and in accordance with a determination that a second state in the first sequence of states has been reached, wherein the second state is different from the first state, generating a set of one or more haptic outputs that indicates that the second state in the first sequence of states have been reached (e.g., at the computer system and/or a computer system (e.g., a wearable device, smart watch, wrist-worn fitness tracker, and/or wrist-worn device) that is different from the computer system). In some embodiments, the set of one or more haptic outputs that indicates the first state in the first sequence of states has been reached is different from (e.g., includes haptic outputs that are generated at different point in time, longer/shorter haptic outputs, and/or stronger/weaker haptic outputs) the set of one or more haptic outputs that indicates the second state in the first sequence of states has been reached. In some embodiments, the set of one or more haptic outputs that indicates the first state in the first sequence of states has been reached and the set of one or more haptic outputs that indicates the second state in the first sequence of states has been reached are generated concurrently with and/or in conjunction with (e.g., before, while, and/or after) one or more audio and/or visual outputs). Generating different sets of haptic outputs at different states provides the user with feedback concerning performance of different states of the first operation, which can also reduce the number of inputs needed to reverse performance of the operation when the user unintentionally causes the first operation.

In some embodiments, performing the first operation based on the air gesture includes transitioning (e.g., navigating, changing, and/or displaying) through a second sequence of states (e.g., transitioning from representations 720d to 720a, in reverse sequence) (e.g., a list of items, a set of user interface, one or more system states (e.g., on, sleep, and/or off; volume levels; brightness levels; and/or contrast levels)). In some embodiments, while transitioning through the sequence of states, computer system detects that a particular state (e.g., an end state (e.g., end of a list, last user interface in a set of user interface, last system state)) in the sequence of states has been reached (and/or will be reached and/or that the particular state is next in the sequence of states); and in response to detecting that the particular state has been reached, the computer system generates a set of one or more haptic outputs that indicates that the particular state in the sequence of states has been reached (e.g., a set of end-of-list haptic outputs and/or a set of particular haptic outputs that correspond to the particular state) (e.g., to indicate that the particular state has been reached) (e.g., at the computer system and/or a computer system (e.g., a wearable device, smart watch, wrist-worn fitness tracker, and/or wrist-worn device) that is different from the computer system). Generating a set of one or more haptic outputs that indicates that the particular state in the sequence of states has been reached in response to detecting that the particular state has been reached provides the user with feedback that a particular state of the first operation has been reached, which can also reduce the number of inputs needed to attempt to continue performing the operation.

In some embodiments, while performing the first operation based on the air gesture, the computer system detects a first change to the air gesture that includes the rotation of the hand (e.g., as described with reference to FIGS. 7C-7D and the operation of a jog-like dial); and in response to detecting the first change to the air gesture that includes the rotation of the hand and in accordance with a determination that the rotation of the hand has stopped (e.g., ceased and/or discontinued rotating around an axis) while (and, in some embodiments, but and/or and) the hand has continued to perform the pinch gesture, the computer system continues to perform the first operation (e.g., based on the air gesture). In some embodiments, in response to detecting the first change to the air gesture that includes the rotation of the hand and in accordance with a determination that the rotation of the hand has stopped and the hand has not continued to perform the pinch gesture, the computer system ceases to perform the first operation based on the air gesture. Continuing to perform the operation in response to detecting the first change to the air gesture that includes the rotation of the hand and in accordance with a determination that the rotation of the hand has ceased while the hand has continued to perform the pinch gesture provides the user with control over continuing to perform the first operation without cluttering the user interface.

In some embodiments, while performing the first operation based on the air gesture, detecting a second change to the air gesture that includes the rotation of the hand; and in response to detecting the second change to the air gesture that includes the rotation of the hand and in accordance with a determination that the hand has changed from being rotated in a first direction to be rotated in a second direction that is different from the first direction, ceasing to perform the first operation (e.g., as described with reference to FIGS. 7C-7D and the effect of reversing direction after maintaining the 2nd portion of the hand gesture). In some embodiments, in response to detecting the second change to the air gesture that includes the rotation of the hand and in accordance with a determination that the hand has not changed from being rotated in the first direction, the computer system continues to perform the first operation based on the air gesture. Ise, in response to detecting the second change to the air gesture that includes the rotation of the hand and in accordance with a determination that the hand has changed from being rotated in a first direction to be rotated in a second direction that is different from the first direction, the computer system reverses performance of the operation. Ceasing to perform the first operation in response to detecting the second change to the air gesture that includes the rotation of the hand and in accordance with a determination that the hand has changed from being rotated in a first direction to be rotated in a second direction that is different from the first direction provides the user with control over stopping the performance of the first operation without cluttering the user interface. Ceasing to perform the first operation in response to detecting the second change to the air gesture that includes the rotation of the hand and in accordance with a determination that the hand has changed from being rotated in a first direction to be rotated in a second direction provides the user with control over ceasing performance of the first operation without cluttering the user interface.

In some embodiments, while performing the first operation based on the air gesture and in accordance with a determination that a first portion of the first operation is being (or has been) performed, generating a set of one or more haptic outputs (e.g., at the computer system and/or a computer system (e.g., a wearable device, smart watch, wrist-worn fitness tracker, and/or wrist-worn device) that is different from the computer system) that indicate that the first portion of the first operation is being performed (e.g., a first portion of haptic output 770c when 720c is displayed); and while performing the first operation based on the air gesture and in accordance with a determination that a second portion of the first operation is being (or has been) performed, wherein the second portion of the first operation is different from the first portion of the operation, generating a set of one or more haptic outputs that indicate that the second portion of the first operation is being performed (e.g., a second portion of haptic output 770c when 720d is displayed) (and, in some embodiments the set of one or more haptic outputs that indicate that the second portion of the first operation is being performed is different from the set of one or more haptic outputs that indicate that the first portion of the operation is being performed) (e.g., at the computer system and/or a computer system (e.g., a wearable device, smart watch, wrist-worn fitness tracker, and/or wrist-worn device) that is different from the computer system). Generating the set of one or more haptic outputs that indicate that the first portion of the first operation is being performed and the set of one or more haptic outputs that indicate that the second portion of the first operation is being performed while performing the first operation based on the air gesture provides the user with feedback concerning performance of the first operation, which can also reduce the number of inputs needed to reverse performance of the operation when the user unintentionally causes the first operation.

In some embodiments, performing the first operation based on the air gesture includes: in accordance with a determination that the air gesture is being performed at a first speed, generating a set of haptics that indicate that the air gesture is being performed at the first speed (e.g., where the first operation is being performed based on the first speed); and in accordance with a determination that the air gesture is being performed at a second speed that is different from the first speed, generating a set of haptics that indicate that the air gesture is being performed a second speed (e.g., the speed and/or rate of the rotation of the hand and/or angular distance of the rotation of the hand) that is different from the first speed (e.g., as described with reference to FIG. 7C and haptic output 770c) (e.g., where the first operation is being performed based on the second speed).

In some embodiments, the first operation is performed at a first rate in response to detecting the air gesture and, while performing the first operation at the first rate (e.g., and while continuing to detect the air gesture (and, in some embodiments, without detecting that the pinch gesture of the air gesture has been released) and in response to detecting the air gesture), the computer system detects an additional rotation of the hand while the hand is performing the pinch gesture; and in response to detecting the additional rotation of the hand while the hand is performing the pinch gesture, the computer system performs the first operation at a second rate that is different from (e.g., faster than or slower than) the first rate (e.g., as described with reference to FIG. 7C). Performing the first operation at a second rate that is different from the first rate in response to detecting the additional rotation of the hand while the hand is performing the pinch gesture provides the user with control over how fast the first operation is performed without cluttering the user interface.

In some embodiments, while performing the first operation based on the air gesture, detecting a third change (e.g., 750a4) to the air gesture that includes the rotation of the hand; and in response to detecting the third change to the air gesture that includes the rotation of the hand and in accordance with a determination that the hand is no longer performing the pinch gesture, forgoing performance of the first operation (e.g., as seen in FIG. 7E) (e.g., irrespective of whether rotation of the has continued to be performed). In some embodiments, after forgoing performance of the first operation, the computer system continues to be in a state in which the first operation was at the time and/or before the hand was determined to no longer be performing the pinch gesture. In some embodiments, when the first operation includes scrolling through a list, the computer system stops scrolling the list and the list is maintained at the location that the list was in at the time and/or after the time that the determination was made that the hand is no longer performing the pinch gesture. In some embodiments, when the first operation includes setting a value, the computer system selects a value that was displayed and/or selected at the time and/or after the time that the determination was made that the hand is no longer performing the pinch gesture. Forgoing performance of the first operation in response to detecting the third change to the air gesture that includes the rotation of the hand and in accordance with a determination that the hand is no longer performing the pinch gesture provides the user with control over whether or not the first operation continues to be performed without cluttering the user interface.

In some embodiments, the first operation is an operation that is performed with respect to one or more virtual objects in an extended reality environment (e.g., as described with reference to FIG. 7A).

In some embodiment, the computer system is in communication with a display generation component (e.g., 700a), and wherein the first set of criteria includes a criterion that is satisfied when the display generation component is in an active state (e.g., an on state and/or a non-sleep state) (e.g., or not in an active state or in an inactive state (e.g., an off state and/or a sleep state)). Choosing to not perform a first operation based on the air gesture in response to detecting the air gesture and in accordance with a determination that the air gesture satisfies a first set of criteria, where the first set of criteria includes a criterion that is satisfied when the display generation component is in an active state allows the computer system to not automatically perform the operation in certain situations irrespective of whether the air gesture included a pinch gesture and a rotation of the hand.

In some embodiments, the air gesture is detected while displaying a first virtual object (e.g., 710a) and a second virtual object (e.g., camera icon of FIG. 7A) that is different from the first virtual object, and wherein: in response to detecting the air gesture: in accordance with a determination that the air gesture satisfies the first set of criteria while attention of the user is directed to the first virtual object, the first operation is performed with respect to the first virtual object (and not with respect to the second virtual object); and in accordance with a determination that the air gesture satisfies the first set of criteria while attention of the user is directed to the second virtual object (and not the first virtual object), the first operation is performed with respect to the second virtual object (e.g., as described with reference to FIG. 7B and the operations in FIGS. 11E-11H). Choosing to perform the first operation with respect to a particular object based on attention of the user being directed to the particular object provides the user with control over how the first operation is performed without cluttering the user interface.

In some embodiments, the air gesture is detected while displaying a third virtual object (e.g., 710a), and wherein: in response to detecting the air gesture: in accordance with a determination that the air gesture satisfies the first set of criteria while attention of the user is directed to the third virtual object and the third virtual object is responsive to a rotation of the hand, the first operation is performed with respect to the third virtual object (and not with respect to the second virtual object) and based on movement of the hand; and in accordance with a determination that the air gesture satisfies the first set of criteria while attention of the user is directed to the third virtual object and the third virtual object is responsive to a rotation of the hand, the first operation is not performed with respect to the third virtual object (e.g., as described with reference to FIG. 7B) (and not based on movement of the hand) (e.g., and/or the first operation is not performed at all and/or the first set of criteria is not satisfied). Choosing whether or not to perform the first operation with respect to the third virtual object and based on movement of the hand in accordance with a determination that the air gesture satisfies the first set of criteria while attention of the user is directed to the third virtual object and the third virtual object is responsive to a rotation of the hand allows the computer system to automatically perform the first operation with respect to an object when the object is responsive to the rotation of the hand.

In some embodiments, the first set of criteria includes a criterion that is satisfied when attention of the user is directed to a first location, and wherein attention of the user is determined based on the gaze of the user being directed to the first location (e.g., as indicated by 754a). Choosing whether or not to perform a first operation based on the air gesture in response to detecting the air gesture and in accordance with a determination that the air gesture satisfies a first set of criteria, where the first set of criteria includes a criterion that is satisfied when attention of the user is directed to a first location and attention of the user is determined based on the gaze of the user being directed to the first location provides more control to the user to cause performance of the first operation by making a particular gesture without requiring additional controls and/or virtual objects that clutter the user interface.

In some embodiments, the first set of criteria includes a criterion that is satisfied when attention of the user is directed to a second location, and wherein attention of the user is determined based on the hand of the user being within a predetermined distance away from (e.g., 0.1-3 meters) (e.g., and/or directed to (e.g., within the general direction of and/or pointing to (e.g., in view of the arm of the user being directed to and/or pointing to))) the second location. Choosing whether or not to perform a first operation based on the air gesture in response to detecting the air gesture and in accordance with a determination that the air gesture satisfies a first set of criteria, where the first set of criteria includes a criterion that is satisfied when attention of the user is directed to a second location and attention of the user is determined based on the hand of the user being within a predetermined distance away from provides more control to the user to cause performance of the first operation by making a particular gesture without requiring additional controls and/or virtual objects that clutter the user interface.

In some embodiments, performing the first operation based on the air gesture includes: in response to detecting a first portion of the air gesture that includes a pinch and hold gesture, displaying a plurality of virtual objects that includes a virtual object that corresponds to a first application (e.g., a browser application, a note-taking application, a stocks application, a word processing application, a messaging application, and/or a social media application); and while displaying the plurality of virtual objects and while continuing to detect the air gesture, detecting a second portion of the air gesture that includes the rotation of the hand; in response to detecting the second portion of the air gesture that includes the rotation of the hand, updating an appearance of a user interface that includes the plurality of virtual objects, including indicating that input focus has moved from the virtual object that corresponds to the first application to a virtual object that corresponds to the second application that is different from the first application. In some embodiments, indicating the input focus has moved includes one or more of moving a focus ring between virtual objects, moving a virtual objects around the display, such that the virtual object that is in focus is at a particular position on the display (e.g., center, middle, prominent, left, and/or right position), highlighting the virtual object that is in focus, emphasizing the virtual object that is in focus and deemphasizing one or more virtual objects that are not in focus, and/or changing the size of the virtual object in focus to be different from the sizes of one or more virtual objects that are not in focus; while updating an appearance of a user interface (and, in some embodiments, while concurrently displaying multiple virtual objects and/or while causing display of one or more virtual objects and ceasing to display one or more other virtual objects) and while indicating that the virtual object that corresponds to the second application has input focus, detecting a third portion of the air gesture that includes release of the pinch and hold gesture; and in response to detecting the third portion of the air gesture that includes release of the pinch and hold gesture while displaying the virtual object that corresponds to the second application, displaying a user interface that corresponds the second application (e.g., launching and/or opening the second application) (e.g., as described with reference to the sequence of inputs and operations of FIGS. 7A-7E). In some embodiments, the second application was not previously displayed before the air gesture was detected. In some embodiments, the first application is displayed while and/or when the air gesture was initially detected.

Displaying a user interface that corresponds the second application in response to detecting the third portion of the air gesture that includes release of the pinch and hold gesture while displaying the virtual object that corresponds to the second application (and while transitioning through the plurality of virtual objects and while displaying the virtual object that corresponds to the second application) provides more control to navigate between applications.

In some embodiments, aspects/operations of methods 800, 1000, and/or 1200, as described herein may be interchanged, substituted, and/or added between these methods. For example, the first gesture of method 1000 and/or the input of method 1200 can be the air gesture of method 800. For brevity, these details are not repeated here.

FIGS. 9A-9D illustrate examples of techniques for audio playback adjustment using gestures. FIG. 10 is a flow diagram of an exemplary method 1000 for audio playback adjustment using gestures. The diagrams in FIGS. 9A-9D are used to illustrate the processes described below, including the processes in FIG. 10.

FIG. 9A illustrates user 901 wearing wearable device 702 on his right hand. As noted above, wearable device 702 includes one or more sensors (e.g., one or more heart rate and/or blood pressure sensors (e.g., one or more light-emitting elements and/or optical sensors on the back side of the device that is oriented towards the wrist of user 901), accelerometers and/or gyroscopes) that detect the movement (e.g., rotation and/or lateral movement), orientation, gestures, and positioning of the right hand of user 901. User 901 is also wearing a headphone device 900, which is a wireless headphone that is in communication with device 702. In some embodiments, user 901 is also wearing a second headphone device in the user's other ear. In such embodiments, the operations discussed with respect to the embodiment of FIGS. 9A-9D can occur on both headphone devices, based on the described gestures. In some embodiments, headphone device includes one or more features of computer system 101. In some embodiments, both wearable device 702 and headphone device 900 are connected (e.g., wirelessly) to another external device, such as a smartphone, a tablet computer, and/or a head-mounted display device. In some embodiments, headphone device 900 is the audio component (e.g., integrated speakers) of a head-mounted display (e.g., an HMD) device. In such embodiments, the operations discussed with reference to FIGS. 9A-9D can permit a user to adjust audio playback using one or more hand gestures without requiring the user to make contact (e.g., provide touch inputs) to headphone device 900 and/or wearable device 702. Control via hand gestures can be especially useful for an HMD as hardware elements (e.g., buttons or touch-sensitive surfaces) of the HMD may not be visible to the user while wearing the HMD and/or may be difficult to operate due to their position and/or lack of visibility.

In FIG. 9A, user 901 is currently listening to song #1, via headphone device 900, as indicated by illustrative text 920. Playback of song #1 is currently occurring at 50% volume, as indicated by illustrative indication 910a. In the embodiment of FIGS. 9A-9D, illustrative elements such as text 920 and indication 910a are provided for illustrative purposes only and are not part of any user interface provided by device 702 and/or device 900.

In FIG. 9A, while device 702 detects that the right hand of user 901 is at the user's side, device 702 detects a first input that is a hand gesture of a first type, as indicated by illustrative text 950a. In some embodiments the gesture of the first type is an air gesture, such as a pinch and rotate as discussed above with reference to FIGS. 7B and 7C. In some embodiments, the air gesture is a different air gesture, such as a tapping gesture made with the forefinger or middle finger (e.g., a mid-air tap that does not involve contacting either device 700 or device 702 with the user's fingers) or positioning the user's fingers in a predetermined pose (e.g., a “C” shape made with the thumb and forefinger).

At FIG. 9B, in response to detecting the first input that corresponds to illustrative text 950a, device 702 transmits an indication of the detected first input to headphone device 900 (e.g., directly or indirectly (e.g., via an external device (e.g., a smartphone) that is connected to both device 702 and device 900)). After receiving the indication of the detected first input, device 900 continues the same audio playback operation (e.g., playback of song #1 at 50% volume), without any modifications and/or adjustments based on receiving the indication of the detected input, as indicated by illustrative text 910a and illustrative text 920. Device 900 does not modify and/or adjust the audio playback operation based on the first input because the hand gesture of the first type was detected while the user's hand was detected as being by the user's side (in some embodiments, because the gesture was not detected while the hand was in detected to be in a predefined position (e.g., within a predetermined distance from the user's head)). In some embodiments, based on detecting the first input, a different operation that does not affect audio playback is performed. For example, device 702 can transmit an indication of the detected first input to an external device (e.g., a smartphone or an HMD) that, in response, performs one or more of the operations described with reference to FIGS. 7A-7E. In another example, headphone device 900 performs a different, non-audio playback adjustment operation in response to the first input of FIG. 9A, such as outputting an indication of battery power while continuing to playback song #1 at 50% volume. In yet another example, device 702 can transmit an indication of the detected first input to an external device (e.g., a smartphone or an HMD) that is presenting an extended reality environment and that, in response to the first input, performs one or more operations that affect the extended reality environment (e.g., moving one or more virtual objects that are a part of the extended reality environment).

At FIG. 9B, while headphone device 900 continues to playback song #1 at 50% volume, device 702 detects a second user input that includes user 901 performing a gesture of the first type (e.g., a gesture of the same type as performed in FIG. 9A) while the right hand of the user is positioned adjacent to the user's head (e.g., within a predetermined distance (e.g., 1-15 inches) of the user's head), as indicated by illustrative text 950b.

At FIG. 9C, in response to detecting the second input that corresponds to illustrative text 950b, device 702 transmits an indication of the detected second input to headphone device 900 (e.g., directly or indirectly) and outputs haptic output 970a. Headphone device 900, in response to receiving the indication of the detected second input, adjusts a property of the ongoing audio playback. Specifically, as shown in FIG. 9C and as indicated by illustrative text 910b, headphone device 900 adjusts the volume of playback from 50% to 75%, while continuing to playback song #1. In some embodiments, a component of the adjustment is based on a characteristic of the input. For example, in some embodiments, when the second input includes rotation of the user's hand, the direction of the adjustment is determined based on a direction of the rotation (e.g., clockwise for an increase in volume and counter-clockwise for a decrease in volume); further, a magnitude of the adjustment is based on the speed and/or angular distance of the rotation (e.g., each degree of change in angular distance results in a 1%, 5%, or 10% increase or decrease in the volume). In some embodiments, one or more properties of haptic output 970a (e.g., duration, amplitude, pattern, and/or frequency) are based on one or more characteristics of the second input (e.g., the speed of rotation, angular distance, and/or resting position of the hand at the end of the rotation) and/or the current operation. For example, in some embodiments, a discrete haptic output (e.g., a discretely perceptible vibration) is outputted for each predetermined unit of increase in volume (e.g., a discrete haptic vibration for every 1%, 5%, or 10% of increase in volume).

At FIG. 9C, while headphone device 900 continues to playback song #1 at 75% volume, device 702 detects a third user input that includes user 901 performing a gesture of a second type (e.g., a gesture of a type different than the gesture performed in in FIGS. 9A and 9B) while the right hand of the user is positioned adjacent to the user's head (e.g., within a predetermined distance (e.g., 1-15 inches) of the user's head), as indicated by illustrative text 950c. In some embodiments the gesture of the second type is an air gesture, such as movement of the user's thumb along the length of the user's forefinger (e.g., a finger slide gesture). In some embodiments, the air gesture is a different air gesture, such as a tapping gesture made with the forefinger or middle finger (e.g., a mid-air tap that does not involve contacting either device 700 or device 702 with the user's fingers) or positioning the user's fingers in a predetermined pose (e.g., a “V” shape made with the thumb and forefinger).

At FIG. 9D, in response to detecting the third input that corresponds to illustrative text 950c, device 702 transmits an indication of the detected third input to headphone device 900 (e.g., directly or indirectly) and outputs haptic output 970b. Headphone device 900, in response to receiving the indication of the detected third input, adjusts a property of the ongoing audio playback. Specifically, as shown in FIG. 9D and indicated by illustrative text 930, headphone device 900 transitions from playback of song #1 to playback of song #2 (e.g., performs a track skip operation), while continuing to output audio at 75%. In some embodiments, a component of the adjustment is based on a characteristic of the input. For example, in some embodiments, when the third input includes sliding the user's thumb across the user's forefinger, the direction of the adjustment (e.g., going to the previous track or the next track) is determined based on a direction of the slide (e.g., forward to skip to a next track and backwards to go to the previous track); further, a magnitude of the adjustment is based on the speed and/or distance of the slide (e.g., sliding a greater distance and/or a higher speed can result in skipping two or more tracks forward or back). In some embodiments, the audio playback adjustment operation is pausing or resuming playback (e.g., when the third input includes a pinch-and-release air gesture). In some embodiments, one or more properties of haptic output 970b (e.g., duration, amplitude, pattern, and/or frequency) are based on one or more characteristics of the second input (e.g., the speed of rotation, angular distance, and/or resting position of the hand at the end of the rotation) and/or the current operation. For example, in some embodiments, a discrete haptic output (e.g., a discretely perceptible vibration) is outputted as each track is skipped.

Additional descriptions regarding FIGS. 9A-9D are provided below in reference to method 1000 described with respect to FIGS. 9A-9D.

FIG. 10 is a flow diagram of an exemplary method 1000 for audio playback adjustment using gestures, in accordance with some embodiments. In some embodiments, method 1000 is performed at a computer system (e.g., computer system 101 in FIG. 1; devices, 900, 700, or 702) (e.g., a smartphone, a desktop computer, a laptop, a tablet, a smartwatch, a heads-up display unit, a head-mounted display unit, an optical head-mounted display unit, a head mounted augmented reality and/or extended reality device, a set of headphones, and/or a wearable device) that is in communication with one or more inputs devices (e.g., a camera; a gyroscope; an accelerometer; an acoustic sensor; and/or a physiological sensor (e.g., a blood pressure sensor and/or a heart rate sensor)). In some embodiments, the one or more input devices are integrated into an external device (e.g., a smartwatch, a smartphone, and/or a wearable device) that is in communication with the computer system. In some embodiments, the computer system is in communication with a display generation component (e.g., a display controller, a touch-sensitive display system, and/or a head mounted display system). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1000 are, optionally, combined and/or the order of some operations is, optionally, changed.

Computer system (e.g., 900) detects (1002) (and, in some embodiments, while an audio playback operation is occurring), via the one or more input devices, a first gesture (e.g., 950a or 950b) (e.g., an air gesture) performed by a first hand (e.g., a hand of a user of the computer system).

In response to detecting the first gesture (1004) and in accordance with a determination that the first gesture (e.g., 950b) satisfies a first set of criteria, wherein the first set of criteria includes a criterion that is satisfied when the first gesture includes the first hand being in (e.g., raised into and/or moved into) a first position that is at least a threshold distance (e.g., 1-20 cm) from (e.g., above and/or above and at a position of) a first body part of a user (e.g., an ear of the user, a head of the user, and/or a body part of a user that on which an external device (e.g., a wearable device (e.g., a set of headphones, earbuds, and/or a head mounted display system))), the computer system performs (1006) an audio playback adjustment operation (e.g., lowering volume as in FIG. 9C; changing tracks as in FIG. 9D) (e.g., pause, play, rewind, fast forward, increase and/or decrease volume, skip forward through content or between content items, and/or skip back through content or between content items). In some embodiments, performing the audio playback operation includes sending instructions to an external device (e.g., a set of headphones and/or earbuds and/or a computer system that is different form the computer system) that causes the audio playback adjustment operations to be performed at the external device.

In response to detecting the first gesture (1004) and in accordance with a determination that the first gesture (e.g., 950a) does not satisfy the first set of criteria, the computer system forgoes (e.g., as seen in FIG. 9B) (1008) performing the audio playback adjustment operation (e.g., forgoing performing any operation based on detecting the first gesture and/or performing an operation different than the audio playback adjustment operation). In some embodiments, as a part of performing the audio playback operation, the computer system causes an external device (e.g., a set of headphones and/or a wearable device) to perform the operation. Choosing whether or not to perform the audio playback adjustment operation in response to detecting the first gesture and in accordance with a determination that the first gesture satisfies a first set of criteria, where the first set of criteria includes a criterion that is satisfied when the first gesture includes the first hand being in a first position that is at least a threshold distance from a first body part of a user provides more control to the user to cause performance of the audio playback adjustment operation by making a particular gesture without requiring additional controls and/or virtual objects that clutter the user interface.

In some embodiments, the first gesture includes detecting the first hand being raised from a second position (e.g., a position that is different from and/or not the same as the first position and/or a position that is not at least the threshold distance from the first body part of the user) to the first position (e.g., as seen in FIGS. 9A-9B). In some embodiments, as a part of detecting the first gesture, the computer system detects that the first hand is lowered from a third position to the first position and/or a position that is not at least the threshold distance from the first body part of the user. Choosing whether or not to perform the audio playback adjustment operation in response to detecting the first gesture and in accordance with a determination that the first gesture satisfies a first set of criteria, where the first set of criteria includes a criterion that is satisfied when the first gesture includes the first hand is raised to the first position provides more control to the user to cause performance of the audio playback adjustment operation by making a particular gesture without requiring additional controls and/or virtual objects that clutter the user interface.

In some embodiments, in response to detecting the first gesture: in accordance with a determination that the first gesture (e.g., 950a) does not satisfy the first set of criteria, performing an operation that is different from the audio playback adjustment operation (e.g., as described with reference to FIG. 9B) (and, in some embodiments, without causing an external device to perform an operation). Performing an operation that is different from the audio playback adjustment operation in response to detecting the first gesture and in accordance with a determination that the first gesture does not satisfy a first set of criteria provides more control to the user to cause performance of an operation that is different from the audio playback adjustment operation.

In some embodiments, the operation that is different from the audio playback adjustment operation is an operation that changes one or more aspects of an extended-reality environment (e.g., as described with reference to FIG. 9B) (e.g., an extended reality environment that is displayed by the computer system and/or displayed by a display generation component that is in communication with the computer system). Performing an operation that changes one or more aspects of an extended-reality environment in response to detecting the first gesture and in accordance with a determination that the first gesture does not satisfy a first set of criteria provides more control to the user to cause performance of an operation that changes one or more aspects of the extended-reality environment.

In some embodiments, the first gesture is detected while a set of headphones (e.g., 900) (e.g., that are in communication with the computer system) is playing audio, and wherein performing the audio playback adjustment operation includes causing the set of headphones to perform the audio playback adjustment operation (e.g., adjusting volume as in FIG. 9C). Choosing whether or not to cause the set of headphones to perform the audio playback adjustment operation in response to detecting the first gesture and in accordance with a determination that the first gesture satisfies the first set of criteria provides the user with control to cause the set of headphones to perform the audio playback adjustment operation without requiring additional controls and/or virtual objects that clutter the user interface.

In some embodiments, the first gesture is detected while an extended-reality device (e.g., a head mounted display unit, a smartphone, a laptop, and/or a tablet) is playing audio (e.g., because the extended-reality device is displaying an extended-reality user interface (e.g., an extended-reality user interface that is associated with the audio being played back (e.g., a music user interface and/or a user interface that includes an indication that audio is being played back))), and wherein performing the audio playback adjustment operation includes causing the extended-reality device to perform the audio playback adjustment operation. Choosing whether or not to cause the extended-reality device to perform the audio playback adjustment operation in response to detecting the first gesture and in accordance with a determination that the first gesture satisfies the first set of criteria provides the user with control to cause the extended-reality device to perform the audio playback adjustment operation without requiring additional controls and/or virtual objects that clutter the user interface.

In some embodiments, before detecting the first gesture performed by the first hand, a first media item (e.g., 920) was being played back (e.g., by the computer system, an extended-reality device, a set of headphones, and/or a computer system that is different form the computer system); the first gesture is a pinch gesture (e.g., a single pinch gesture, a multi-pinch gesture, and/or, in some embodiments, a tap gesture and/or a sliding gesture); and performing the audio playback adjustment operation in response to detecting the first gesture includes playing or pausing the first media item (e.g., as described with reference to FIG. 9D). In some embodiments, in response to detecting the first gesture while the computer system is playing back the first media item, the computer system (or another computer system/device) pauses the first media item. In some embodiments, in response to detecting the first while the computer system (or another computer system/device) is not playback the first media item (and, in some embodiments, is configured to playback the first media item), the computer system (or another computer system/device) plays the first media item. In some embodiments, playing the first media item or pausing the first media item includes sending and/or transmitting a set of instructions that causes an extended-reality device, a set of headphones, and/or a computer system that is different form the computer system to play the first media item and/or pause the first media item. Choosing whether or not to play or pause the first media item in response to detecting the first gesture that is a pinch gesture and in accordance with a determination that the first gesture satisfies the first set of criteria provides the user with control to play or pause the first media item without requiring additional controls and/or virtual objects that clutter the user interface.

In some embodiments, before detecting the first gesture performed by the first hand, a second media item (e.g., 920 or 930) is being played back (e.g., by the computer system, an extended-reality device, a set of headphones, and/or a computer system that is different form the computer system); the first gesture is a gesture that includes a finger of the first hand that is moved (e.g., swiped and/or dragged along the first hand) relative to a portion (e.g., a portion that does not include the finger of the first hand and/or another finger of the first hand that is different from the finger of the first hand) of the first hand (e.g., as described with reference to FIG. 9D); and performing the audio playback adjustment operation in response to detecting the first gesture includes changing playback of (e.g., fast-forwarding or rewinding) the second media item (e.g., as described with reference to FIG. 9D). In some embodiments, fast-forwarding or rewinding the second media item includes sending and/or transmitting a set of instructions that causes an extended-reality device, a set of headphones, and/or a computer system that is different form the computer system to fast-forward or rewind the second media item and/or pause the second media item. In some embodiments, in accordance with a determination that the first gesture is in a first direction, changing playback of the second media item includes fast-forwarding a media item (e.g., the currently playing media item and/or the media item that is currently configured to be played back) (or, in some embodiments, skipping to the next media item). In some embodiments, in accordance with a determination that the first gesture is in a second direction that is different from the second direction, changing playback of the second media item includes rewinding a media item e.g., the currently playing media item and/or the media item that is currently configured to be played back (or, in some embodiments, going back to a previous media item). Choosing whether or not to fast-forward or rewind the second media item in response to detecting a gesture that includes a finger of the first hand that is moved relative to a portion of the first hand and in accordance with a determination that the first gesture satisfies the first set of criteria provides the user with control to fast-forward or rewind the second media item without requiring additional controls and/or virtual objects that clutter the user interface.

In some embodiments, before detecting the first gesture performed by the first hand, the computer system displays (and/or, in some embodiments, causing another display to display extended-reality device, a set of headphones, and/or a computer system that is different form the computer system) a user interface (e.g., 700b) with a first amount of transparency (e.g., and/or is configured to operate in a first transparency mode); while the computer system is displaying the user interface with the second amount of transparency, detecting, via the one or more inputs devices, a tap gesture (e.g., a double tap gesture, a single tap gesture, and/or, in some embodiments, a pinch gesture, a mouse click gesture, and/or a sliding gesture) performed by the first hand; and in response to detecting the second gesture and in accordance with a determination that the second gesture satisfies the second set of criteria, displaying the user interface with a second amount of transparency that is different from the first amount of transparency (e.g., configuring the computer system to operate in a second transparency mode that is different from the first transparency mode). Displaying the user interface with a second amount of transparency that is different from the first amount of transparency in response to detecting the second gesture and in accordance with a determination that the second gesture satisfies the second set of criteria provides the user with control to change the amount of transparency of the user interface without requiring additional controls and/or virtual objects that clutter the user interface.

In some embodiments, before detecting the first gesture performed by the first hand, a third media item (e.g., 920 or 930) is configured to be played back (e.g., by the computer system, an extended-reality device, a set of headphones, and/or a computer system that is different form the computer system) at a first volume level (e.g., 910a or 910b); the first gesture is a first pinch gesture that that is rotated (e.g., 950b) (e.g., or a double tap gesture, a single tap gesture, and/or, in some embodiments, a pinch gesture that is moved (e.g., vertically, inward, outward, and/or horizontally), a mouse click gesture, and/or a sliding gesture); and performing the audio playback adjustment operation in response to detecting the first gesture includes configuring the third media item to be played back at a second volume level (e.g., 930) that is different from the first volume level (e.g., at the computer system, an extended-reality device, a set of headphones, and/or a computer system that is different form the computer system). In some embodiments, configuring the third media item to be played back at a second volume level that is different from the first volume level includes causing the first volume level to be increased or causing the first volume level to be decreased. In some embodiments, in response to detecting the first gesture and in accordance that the pinch gesture is rotated in a first direction, the second volume level is lower than the first volume level; and, in response to detecting the first gesture and in accordance that the pinch gesture is rotated in a second direction that is different from the first direction, the second volume level is higher than the first volume level. Choosing whether or not to configure the third media item to be played back at a second volume level that is different from the first volume level in response to detecting the first gesture that is a first pinch gesture that that is rotated and in accordance with a determination that the first gesture satisfies the first set of criteria provides the user with control to change the volume level at which third media item is configured to be played back without requiring additional controls and/or virtual objects that clutter the user interface.

In some embodiments, before detecting the first gesture performed by the first hand, a fourth media item (e.g., 920 or 930) is configured to be played back (e.g., by the computer system, an extended-reality device, a set of headphones, and/or a computer system that is different form the computer system) at a third volume level (e.g., 910a); the first gesture is a second pinch gesture that is rotated (e.g., 950b) (e.g., or a double tap gesture, a single tap gesture, and/or, in some embodiments, a pinch gesture that is moved (e.g., vertically, inward, outward, and/or horizontally), a mouse click gesture, and/or a sliding gesture); and performing the audio playback adjustment operation in response to detecting the first gesture includes: in accordance with a determination that the second pinch gesture is rotated at a first rate (e.g., speed, acceleration, rate of movement, and/or velocity), configuring the third media item to be played back at a fourth volume level that is different from the third volume level by a first amount of volume (e.g., as described with reference to FIG. 9C); and in accordance with a determination that the second pinch gesture is rotated at a second rate that is different from the first rate, configuring the third media item to be played back at a fifth volume level that is different from the third volume level by a second amount of volume (e.g., as described with reference to FIG. 9C), wherein the second amount of volume is different from the first amount of volume. In some embodiments, when the second rate is higher than (e.g., faster than) the first rate, the second amount of volume is more than the second amount of volume (and/or the difference act which the volume is changed is increased as the gesture is rotated at a higher rate). Configuring the third media item to be played back by a different amount of volume based on the rate at which the second pinch gesture is rotated provides the user with control over how much the volume level is changed without requiring additional controls and/or virtual objects that clutter the user interface.

In some embodiments, in response to detecting the first gesture and in accordance with a determination that the first gesture satisfies a first set of criteria, generating a first set of haptic outputs (e.g., 970a) (e.g., in conjunction with (e.g., while, before, and/or after) performing the audio playback adjustment operation) that correspond to the audio playback adjustment operation. Generating a first set of haptic outputs that correspond to the audio playback adjustment operation provides the user with feedback concerning performance of the audio playback adjustment operation, which can also reduce the number of inputs needed to reverse performance of the operation when the user unintentionally causes the audio playback adjustment operation.

In some embodiments, a wrist-worn-wearable device (e.g., 702) (e.g., a smart watch, a wrist-worn fitness tracker, a heart rate monitor, and/or other wrist worn device that is capable of detecting hand gestures) includes the one or more input devices (e.g., 244) that are used to detect the first gesture performed by the first hand.

In some embodiments, in response to detecting the first gesture and in accordance with a determination that the first gesture satisfies the first set of criteria, the computer system causes the wrist-worn-wearable device (e.g., 702) to generate a second set of haptic outputs (e.g., 970a) (e.g., in conjunction with (e.g., while, before, and/or after) performing the audio playback adjustment operation) that correspond to the audio playback adjustment operation. Causing the wrist-worn-wearable device to generate a second set of haptic outputs that correspond to the audio playback adjustment operation provides the user with feedback concerning performance of the audio playback adjustment operation, which can also reduce the number of inputs needed to reverse performance of the operation when the user unintentionally causes the audio playback adjustment operation.

In some embodiments, in accordance with a determination that the first gesture (e.g., 950b) (e.g., while in the first position and/or while in at least the threshold distance from the first body part of the user) has a first direction of rotation, the audio playback adjustment operation is a first operation (e.g., decreasing the volume level, rewinding a media item, skipping to the previous media item in queue of media items, and/or decreasing one or more audio characteristics (e.g., bass, balance, pitch, and/or tone)); and in accordance with a determination that the first gesture has a second direction of rotation, the audio adjustment operation is a second operation that is different from the first operation (e.g., as described with reference to FIG. 9C) (e.g., increasing the volume level, fast-forwarding a media item in queue of media items, skipping to the next media item, and/or increasing one or more audio characteristics (e.g., bass, balance, pitch, and/or tone)). Performing the audio playback adjustment operation based on the direction of the rotation allows the user to control the audio playback adjustment operation that is performed without requiring additional controls and/or virtual objects that clutter the user interface.

In some embodiments, in accordance with a determination that the first gesture (e.g., 950b) (e.g., while in the first position and/or while in at least the threshold distance from the first body part of the user) has a first magnitude of rotation (e.g., rate, speed, acceleration, velocity, distance, and/or angular distance), the audio playback adjustment operation has a first magnitude of adjustment (e.g., as described with reference to FIG. 9C) (e.g., decreasing the volume level, rewinding a media item, skipping to the previous media item in queue of media items, and/or decreasing one or more audio characteristics (e.g., bass, balance, pitch, and/or tone) by a first magnitude) (e.g., increasing the volume level, fast-forwarding a media item in queue of media items, skipping to the next media item, and/or increasing one or more audio characteristics (e.g., bass, balance, pitch, and/or tone) by the first magnitude); and in accordance with a determination that the first gesture has a second magnitude of rotation that is different from the first magnitude of rotation, the audio adjustment operation has a second magnitude of adjustment that is different from the third magnitude of adjustment (e.g., decreasing the volume level, rewinding a media item, skipping to the previous media item in queue of media items, and/or decreasing one or more audio characteristics (e.g., bass, balance, pitch, and/or tone) by a second magnitude that is different from the first magnitude) e.g., increasing the volume level, fast-forwarding a media item in queue of media items, skipping to the next media item, and/or increasing one or more audio characteristics (e.g., bass, balance, pitch, and/or tone) by the second magnitude). Performing the audio playback adjustment operation based on the magnitude of the rotation allows the user to control the audio playback adjustment operation that is performed without requiring additional controls and/or virtual objects that clutter the user interface.

In some embodiments, aspects/operations of methods 800, 1000, and/or 1200, as described herein may be interchanged, substituted, and/or added between these methods. For example, the air gesture of method 800 can be the first gesture of method 1000 that conditionally performs and audio playback adjustment. For brevity, these details are not repeated here.

FIGS. 11A-11H illustrate examples of techniques for conditionally responding to inputs. FIG. 12 is a flow diagram of an exemplary method 1200 for conditionally responding to inputs. The diagrams in FIGS. 11A-11H are used to illustrate the processes described below, including the processes in FIG. 12. As discussed in more detail below, those processes include providing a) user interface objects that cause performance of a first operation when a device receives a first type of gesture and performance of a second operation when the device receives a second type of gesture, b) user interface objects that cause performance of a third operation when the device receives either the first or second type of gesture, and/or c) user interface objects that cause performance of a fourth operation when the device receives the first type of gesture but do not cause performance of an operation (e.g., any operation) when the device receives the second type of gesture. In some embodiments, the device is an extended reality device (e.g., a device that presents an extended reality environment to a user), such as a head-mounted device. In such embodiments, presenting a user interface with virtual objects that can respond differently to hand gestures provides a variety of control options, particularly for control via hand gestures. Control via hand gestures can be especially useful for an HMD as hardware elements (e.g., buttons or touch-sensitive surfaces) of the HMD may not be visible to the user while wearing the HMD and/or may be difficult to operate due to their position and/or lack of visibility.

At FIG. 11A, user 701 is holding and interacting with device 700 that is currently displaying a camera user interface 1102 of a camera application. As discussed above, device 700 can include one or more features of computer system 101 (e.g., eye tracking unit 243 that is configured to track the position and movement of the user's gaze); in the embodiment of FIGS. 11A-11H, device 700 includes image sensors 314, which include one or more cameras (e.g., back-facing cameras) that can be used to capture still images and videos using camera user interface 1102. User 701 is also wearing wearable device 702 on her right hand. As noted above, wearable device 702 includes one or more sensors (e.g., one or more heart rate and/or blood pressure sensors (e.g., one or more light-emitting elements and/or optical sensors on the back side of the device that is oriented towards the wrist of user 701), accelerometers and/or gyroscopes) that detect the movement (e.g., rotation and/or lateral movement), orientation, gestures, and positioning of the right hand of user 701.

At FIG. 11A, camera user interface 1102 includes various selectable interface objects, including shutter object 1102a (e.g., for initiating image or video capture), camera roll object 1102b (e.g., for accessing one or more previously captured images or videos), flash control object 1102c (e.g., for selecting and/or modifying a flash mode), and video mode object 1102d (e.g., for selecting a video capture mode). In FIG. 11A, video object 1102d is currently selected (e.g., as indicated by the bolding) so device 700 is configured to capture video media (e.g., when shutter object 1102a is selected). Camera user interface 1102 also includes camera preview object 1104, which is an area of the user interface that provides a preview of image data captured in the field-of-view of one or more cameras of device 700. In FIG. 11A, camera preview object 1104 currently shows that a camera of device 700 is currently pointed to a person playing a guitar. In some embodiments, camera user interface 1102 is a set of virtual objects displayed in a virtual reality environment.

At FIG. 11A, device 700 detects (e.g., alternatively and/or sequentially) that the gaze of user 701 is directed to shutter object 1102a, camera roll object 1102b, and flash control object 1102c, as indicated by illustrative gaze line 752a and gaze target indications 1154a, 1154b, and 1154c, respectively. In the embodiment of FIGS. 11A-11H, illustrative elements such as gaze line 752a and gaze target indications 1154a-c are provided for illustrative purposes only and are not part of the user interfaces provided by devices 700 and/or 702.

Also at FIG. 11A, device 702 detects (in some embodiments, and/or device 700) a first input that is a hand gesture of a first type, while the user's gaze is directed (e.g., alternatively and/or sequentially) to user interface objects 1102a-c, as indicated by illustrative text 1150a. In some embodiments the gesture of the first type is an air gesture, such as a pinch-and-release gesture (e.g., a pinch with the thumb and forefinger that lasts for less than a predetermine period of time) or a pinch and rotate as discussed above with reference to FIGS. 7B and 7C. In some embodiments, the air gesture is a different air gesture, such as a tapping gesture made with the forefinger or middle finger (e.g., a mid-air tap that does not involve contacting either device 700 or device 702 with the user's fingers) or positioning the user's fingers in a predetermined pose (e.g., a “C” shape made with the thumb and forefinger).

At FIG. 11B, in response to detecting the first input that corresponds to illustrative text 1150a while the gaze of user 701 is directed to shutter object 1102a (e.g., as illustrated by gaze target 1154a in FIG. 11A), device 702 transmits an indication of the detected first input to device 700. Device 700, in response to receiving the indication of the first input while the user's gaze is directed to shutter object 1102a, initiates a process to record video, as indicated by shutter object 1102a being replaced with stop object 1102e and record time object 1102f beginning to count up. Thus, device 700 performs a first operation (e.g., initiating video recording) corresponding to shutter object 1102a when the gesture of a first type is detected while the user's attention is directed to shutter object 1102a. In some embodiments, in response to detecting the first input that corresponds to illustrative text 1150a, device 702 and/or device 700 outputs a haptic output (e.g., to indicate that the gesture was received/recognized). In some embodiments, different haptic outputs are provided for different gesture types (e.g., a single haptic vibration for a pinch-and-release and a two haptic vibrations for a double pinch gesture).

At FIG. 11C, in response to detecting the first input that corresponds to illustrative text 1150a while the gaze of user 701 is directed to camera roll object 1102b (e.g., as illustrated by gaze target 1154b in FIG. 11A), device 702 transmits an indication of the detected first input to device 700. Device 700, in response to receiving the indication of the first input while the user's gaze is directed to camera roll object 1102b, displays camera roll interface 1106 which includes media representation 1106a of a previously captured image (e.g., captured before the depiction of FIG. 11A). Thus, device 700 performs a first operation (e.g., displaying a representation of previously captured media) corresponding to camera roll object 1102b when the gesture of a first type is detected while the user's attention is directed to camera roll object 1102b.

At FIG. 11D, in response to detecting the first input that corresponds to illustrative text 1150a while the gaze of user 701 is directed to flash control object 1102c (e.g., as illustrated by gaze target 1154c in FIG. 11A), device 702 transmits an indication of the detected first input to device 700. Device 700, in response to receiving the indication of the first input while the user's gaze is directed to flash control object 1102c, enables an auto flash function, as indicated by the change in appearance of flash control object 1102c. Thus, device 700 performs a first operation (e.g., enabling auto flash) corresponding to flash control object 1102c when the gesture of a first type is detected while the user's attention is directed to flash control object 1102c.

At FIG. 11D, device 700 detects (e.g., alternatively and/or sequentially) that the gaze of user 701 is directed to shutter object 1102a, camera roll object 1102b, and flash control object 1102c, as indicated by illustrative gaze line 752a and gaze target indications 1154d, 1154e, and 1154f, respectively. In some embodiments, device 700 displays a visual indication of the detected user gaze, such as highlighting an object (e.g., shutter object 1102 is highlighted and/or bolded when device 700 determines that the user's gaze is currently directed to shutter object 1102).

Also at FIG. 11D, device 702 detects (in some embodiments, and/or device 700) a second input that is a hand gesture of a second type, different from the first type, while the user's gaze is directed (e.g., alternatively and/or sequentially) to user interface objects 1102a-c, as indicated by illustrative text 1150b and gaze targets 1154d-f, respectively. In some embodiments the gesture of the second type is an air gesture, such as a pinch-and-hold gesture (e.g., a pinch with the thumb and forefinger that is maintained for at least a predetermined period of time before being released) or a pinch and rotate as discussed above with reference to FIGS. 7B and 7C. In some embodiments, the air gesture is a different air gesture, such as a tapping gesture made with the forefinger or middle finger (e.g., a mid-air tap that does not involve contacting either device 700 or device 702 with the user's fingers) or positioning the user's fingers in a predetermined pose (e.g., a “V” shape made with the thumb and forefinger).

In response to detecting the second input that corresponds to illustrative text 1150b while the gaze of user 701 is directed to shutter object 1102a (e.g., as illustrated by gaze target 1154d in FIG. 11D), device 702 transmits an indication of the detected second input to device 700. Device 700, in response to receiving the indication of the second input while the user's gaze is directed to shutter object 1102a, initiates a process to record video, as seen in FIG. 11B, with shutter object 1102a being replaced with stop object 1102e and record time object 1102f beginning to count up. Thus, device 700 performs the same first operation (e.g., initiating video recording) corresponding to shutter object 1102a when the gesture of a second type is detected while the user's attention is directed to shutter object 1102a. In summary, device 700 performs the same operation when either the gesture of a first type or the gesture of a second type is detected while the user's attention is directed to shutter object 1102a. In some embodiments, mapping multiple gestures to the same operation for a virtual object ensures that the operation is performed, without requiring the user to remember a single, precise gesture. In some embodiments, the virtual object is only associated with a single operation and therefore gesture-disambiguation is not required. In some embodiments, the operation is an important or critical operation (e.g., media capture of a potentially transient event) and mapping multiple gestures from a set of recognizable gestures (in some embodiments, mapping all recognizable gestures) reduces the risk that the operation is not performed due to mis-recognition of a gesture and/or user error in providing a desired gesture.

In response to detecting the second input that corresponds to illustrative text 1150b while the gaze of user 701 is directed to camera roll object 1102b (e.g., as illustrated by gaze target 1154e in FIG. 11D), device 702 transmits an indication of the detected second input to device 700. Device 700, in response to receiving the indication of the second input while the user's gaze is directed to shutter object 1102b, maintains display of user interface 1102b as seen in FIG. 11D (e.g., device 700 does not provide a perceptible reaction to the second input). Thus, device 700 does not perform a perceptible operation corresponding to camera roll object 1102b when the gesture of a second type is detected while the user's attention is directed to camera roll object 1102b. In some embodiments, a gesture of a second type does not cause a perceptible operation (e.g., displaying a representation of previously captured media as seen in FIG. 11C) when false positives for the operation are consequential. For example, navigating away from the camera capture user interface 1102, when the user did not intend to do so, can cause a transient media capture opportunity to be missed. In such embodiments, the first operation that corresponds to the camera roll object 1102b is only mapped to a specific set of gesture types (in some embodiments, a single type of gesture).

In response to detecting the second input that corresponds to illustrative text 1150b while the gaze of user 701 is directed to flash control object 1102c (e.g., as illustrated by gaze target 1154f in FIG. 11D), device 702 transmits an indication of the detected second input to device 700. Device 700, in response to receiving the indication of the second input while the user's gaze is directed to flash control object 1102c, switches to a forced-on flash function. Thus, device 700 performs a second operation (e.g., enabling forced-on flash) corresponding to flash control object 1102c when the gesture of a first type is detected while the user's attention is directed to flash control object 1102c. In some embodiments, had the gesture of the second type been detected while flash was off (e.g., as seen in FIG. 11A) and while the attention of the user was directed to flash control object 1102c, the flash function would have transitioned to forced-on flash, rather than auto flash. In some embodiments, a virtual object is associated with three or more operations (e.g., flash off, auto flash, and forced-on flash) and three or more specific gesture types are each mapped to specific operations. For example, a pinch-and-release gesture is mapped to flash off, a pinch-and-hold is mapped to auto flash, and a double pinch gesture is mapped to forced-flash on. In some embodiments, a respective virtual object is associated with a plurality of states (e.g., three or more states such as off, auto flash, and forced-on flash) and receiving a gesture of a first type or a gesture of a second type while the user's attention is directed to the respective virtual object causes the same operation—cycling to the next state in a predetermined sequence of the states.

At FIG. 11E, device 700 detects that the gaze of the user is directed to a location in camera preview object 1104, as indicated by illustrative gaze line 752a and gaze target indication 1154g. Also at FIG. 11E, device 702 detects (in some embodiments, and/or device 700) a third input that is a hand gesture of the first type, while the user's gaze is directed to the location in the camera preview object 1104, as indicated by illustrative text 1150c.

At FIG. 11F, in response to detecting the third input that corresponds to illustrative text 1150c while the gaze of user 701 is directed to the location in the camera preview object 1104, device 702 transmits an indication of the detected third input to device 700. Device 700, in response to receiving the indication of the third input while the user's gaze is directed to the location in the camera preview object 1104, displays exposure adjustment control object 1108. In some embodiments, the gesture of the first type is an air gesture having a magnitude characteristic and/or a direction characteristic (e.g., the gesture of the first type is a finger slide gesture as discussed above with respect to FIG. 9C) and one or more characteristics of the operation is based on the magnitude characteristic and/or the direction characteristic of the gesture (e.g., the change in exposure is based on the direction and distance that the thumb is sliding across the forefinger). Thus, device 700 performs a first operation (e.g., displaying exposure adjustment control object 1108) corresponding to camera preview object 1104 when the gesture of a first type is detected while the user's attention is directed to camera preview object 1104.

At FIG. 11G, device 700 detects that the gaze of the user is directed to the same location in camera preview object 1104 as seen in FIG. 11E, as indicated by illustrative gaze line 752a and gaze target indication 1154g. Also at FIG. 11G, device 702 detects (in some embodiments, and/or device 700) a fourth input that is a hand gesture of the second type, while the user's gaze is directed to the location in the camera preview object 1104, as indicated by illustrative text 1150d.

At FIG. 11H, in response to detecting the fourth input that corresponds to illustrative text 1150d while the gaze of user 701 is directed to the location in the camera preview object 1104, device 702 transmits an indication of the detected fourth input to device 700. Device 700, in response to receiving the indication of the fourth input while the user's gaze is directed to the location in the camera preview object 1104, displays representation 720a that corresponds to a weather application, as described with reference to FIG. 7B, and outputs haptic output 1160a (e.g., similar to haptic output 770a of FIG. 7B). In some embodiments, as discussed with respect to FIGS. 7A-7E, the user can then switch to different applications using additional gestures. Thus, device 700 performs a second operation (e.g., displaying representation 720a) corresponding to camera preview object 1104 when the gesture of the second type is detected while the user's attention is directed to camera preview object 1104. In some embodiments, a third operation (e.g., a system-level operation such as transitioning the device and/or display to a low-power state) is performed when a third type of gesture (e.g., a double pinch gesture). In some embodiments, different operations, mapped to different gesture types, can be performed when the corresponding gesture is detected while the user's attention is directed to a virtual object. In some embodiments, doing so allows multiple operations to be associated with a virtual object without cluttering the user interface with additional displayed control objects.

Additional descriptions regarding FIGS. 11A-11H are provided below in reference to method 1200 described with respect to FIGS. 11A-11H.

FIG. 12 is a flow diagram of an exemplary method 1200 for conditionally responding to inputs, in accordance with some embodiments. In some embodiments, method 1000 is performed at a computer system (e.g., computer system 101 in FIG. 1; devices, 900, 700, or 702) (e.g., a smartphone, a desktop computer, a laptop, a tablet, a smart watch, a wrist-worn fitness tracker, a heads-up display unit, a head-mounted display unit, an optical head-mounted display unit, a head mounted augmented reality and/or extended reality device, and/or a wearable device) that is in communication with a display generation component (e.g., a display controller, a touch-sensitive display system, and/or a head mounted display system) and one or more input devices (e.g., a camera; a gyroscope, an accelerometer, an acoustic sensor, a physiological sensor (e.g., a blood pressure sensor), a keyboard, a touch sensitive surface, a smartwatch, and/or a mouse). In some embodiments, the one or more input devices are integrated into an external device (e.g., a smartwatch and/or a wearable device) that is in communication with the computer system. In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1200 are, optionally, combined and/or the order of some operations is, optionally, changed.

The computer system (e.g., 700 or 702) while displaying, via the display generation component (e.g., 700a), a user interface (e.g., 1102) (e.g., and/or while causing a first user interface to be displayed) that includes a virtual object (e.g., 1102a-c) (e.g., and/or the first virtual object and the second virtual object), detects (1202), via the one or more input devices, an input (e.g., 1150a) (e.g., an input that has a set of characteristics (e.g., a pinch, a pinch and hold, and/or a multi-pinch gesture/input and/or in some embodiments, a non-pinch gesture/input (e.g., such as a click, a click and hold, and/or a multi-click, a tap, a press-and-hold, and/or a multi-tap gesture/input))).

In response to detecting the input (1204) and in accordance with a determination that attention of the user (e.g., a gaze of the user, an object or a body part of a user that is directed to a portion (e.g., a particular portion and/or a predetermined portion) of the user interface) was directed to a first virtual object (e.g., 1154c or 1104) (e.g., a virtual object that is responsive to the first type of input and the second type of input and/or that causes the computer system to perform different operations in response to detecting the first type of input or the second type of input) in conjunction with (e.g., while, after (e.g., immediately after (e.g., within 0-5 seconds after)), and/or before (e.g., immediately before (e.g., within 0-5 seconds) detecting the input and that the input corresponds to a first type of input (e.g., 1150a) (e.g., a pinch, pinch and hold, single pinch, and/or multi-pinch (e.g., double pinch and/or triple pinch))), the computer system performs (1206) a first operation (e.g., as described with reference to FIG. 11D or FIG. 11F) (e.g., select a virtual object, switch between applications, turn a setting on and/or off, and/or capture media) with respect to the first virtual object (e.g., without performing the second operation with respect to the first virtual object).

In response to detecting the input (1204) and in accordance with a determination that attention of the user was directed to the first virtual object in conjunction with detecting the input and that the input corresponds to a second type of input (e.g., 1150b) (e.g., a pinch, pinch and hold, single pinch, and/or multi-pinch (e.g., double pinch and/or triple pinch) input) that is different from the first type of input, the computer system performs (1208) a second operation (e.g., as described with reference to FIG. 11D or FIG. 11H) (e.g., select a virtual object, switch between applications, turn a setting on and/or off, and/or capture media) with respect to the first virtual object (e.g., as described with reference to FIG. 11B, FIG. 11C, or FIG. 11D), wherein the second operation is different from the first operation (e.g., without performing the first operation with respect to the first virtual object).

In response to detecting the input (1204) and in accordance with a determination that attention of the user was directed to a second virtual object (e.g., 1102) (e.g., a virtual object that is responsive to the first type of input (and, in some embodiments, not the second type of input) and/or that causes the computer system to perform the same operation in response to detecting the first type of input or the second type of input) in conjunction with detecting the input, wherein the second virtual object is different from the first virtual object, and that the input corresponds to the first type of input, the computer system performs (1210) the first operation with respect to the second virtual object (e.g., as described with reference to FIG. 11B) (e.g., without performing the second operation with respect to the second virtual object).

In response to detecting the input (1204) and in accordance with a determination that attention of the user was directed to the second virtual object in conjunction with detecting the input and that the input corresponds to the second type of input, the computer system performs (1212) the first operation with respect to the second virtual object (e.g., as described with reference to FIG. 11D) (e.g., without performing the second operation with respect to the second virtual object).

In some embodiments, detecting the first type of input includes detecting that a pinch and release gesture has been performed (e.g., described with reference to FIG. 11A). Performing the same operation or a different operation with respect to a respective virtual object based on the respective virtual object in relation to detecting the pinch and release gesture or the another type of input allows the computer system to automatically choose which operation will be performed based on the type of respective virtual object, where the same operation is performed in some scenarios (e.g., when the respective virtual object is the first virtual object) in response to detecting the pinch and release gesture or the other type of input and a different operation is performed in other scenarios (e.g., when the respective virtual object is the second virtual object).

In some embodiments, detecting the second type of input includes detecting a pinch gesture that has a duration that is longer than a predetermined period of time (e.g., as described with reference to FIG. 11D) (e.g., a non-zero period of time (e.g., 1-5 seconds) and/or a period of time that is longer than zero seconds). Performing the same operation or a different operation with respect to a respective virtual object based on the respective virtual object in relation to detecting the first type of input or a pinch gesture that has a duration that is longer than a predetermined period of time allows the computer system to automatically choose which operation will be performed based on the type of respective virtual object, where the same operation is performed in some scenarios (e.g., when the respective virtual object is the first virtual object) in response to detecting the pinch gesture has been performed for longer than a predetermined period of time or the second type of input and a different operation is performed in other scenarios (e.g., when the respective virtual object is the second virtual object).

In some embodiments, in response to detecting the input and in accordance with a determination that attention of the user was directed to the first virtual object (e.g., 1102c) in conjunction with detecting the input and that the input corresponds to a third type of input that is different from the first type of input and the second type of input, performing a third operation (e.g., as described with reference to FIG. 11D) with respect to the first virtual object, wherein the third operation (e.g., select a virtual object, switch between applications, turn a setting on and/or off, and/or capture media) is different from the first operation and the second operation. Performing a third operation with respect to the first virtual object in accordance with a determination that attention of the user was directed to the first virtual object in conjunction with detecting the input and that the input corresponds to a third type of input that is different from the first type of input and the second type of input provides the user with control to perform a different operation than the first or second operation (e.g., with respect to an object that is responsive to the first operation, the second operation, and the third operation) without cluttering the user interface with additional controls and/or virtual objects.

In some embodiments, detecting the third type of input includes detecting that a multi-pinch gesture (e.g., a double pinch gesture, a triple pinch gesture, and/or a quadruple pinch gesture) has been performed (e.g., as described with reference to FIG. 11D). In some embodiments, the multi-pinch gesture is a gesture where multiple single pinches are detected within a predetermined period of time (e.g., within 0.1-2 seconds of each other); in some embodiments, if one of the single pinches are not detected within a predetermined period of time (e.g., within 0.1-2 seconds) of a previous single pinch, the computer system performs an operation that is different from the third operation. Performing a third operation with respect to the first virtual object in accordance with a determination that attention of the user was directed to the first virtual object in conjunction with detecting the input and that the input corresponds to a multi-pinch gesture provides the user with control to perform a different operation than the first or second operation (e.g., with respect to an object that is responsive to the first operation, the second operation, and the third operation) without cluttering the user interface with additional controls and/or virtual objects.

In some embodiments, performing the third operation with respect to the first virtual object includes performing a system operation (e.g., displaying a system user interface or enabling or disabling a system level function). Performing a system operation with respect to the first virtual object in accordance with a determination that attention of the user was directed to the first virtual object in conjunction with detecting the input and that the input corresponds to a third type of input provides the user with control to perform a different operation than the first or second operation (e.g., with respect to an object that is responsive to the first operation, the second operation, and the system operation) without cluttering the user interface with additional controls and/or virtual objects.

In some embodiments, performing the third operation with respect to the first virtual object includes transitioning the computer system from a first system mode to a second system mode that is different from the first system mode (e.g., as described with reference to FIG. 11H). In some embodiments, as a part of transitioning the computer system from a first system mode to a second system mode that is different from the first system mode, the computer system enables a low power mode and/or a reduced power mode (e.g., a mode that places one or more components (e.g., a display, a display generation component, a processor, and/or connectivity hardware component, such as a Bluetooth hardware module and/or a wireless hardware module of the computer system in a low power state and/or a reduced power state) or a sleep mode (e.g., a display, a display generation component, a processor, and/or connectivity hardware component, such as a Bluetooth hardware module and/or a wireless hardware module) of the computer system in a sleep state) or disables a low power mode or a sleep mode. Transitioning the computer system from a first system mode to a second system mode that is different from the first system mode in accordance with a determination that attention of the user was directed to the first virtual object in conjunction with detecting the input and that the input corresponds to a third type of input provides the user with control to transition the computer system from a first system mode to a second system mode without cluttering the user interface with additional controls and/or virtual objects.

In some embodiments, in response to detecting the input and in accordance with a determination that attention of the user was directed to a portion of the user interface that does not include the second virtual object (e.g., or any virtual object), the computer system performs a fourth operation (e.g., without performing an operation with respect to the second virtual object) (and/or the first operation and/or the second operation). Performing the fourth operation in response to detecting the input and in accordance with a determination that attention of the user was directed to a portion of the user interface that does not include the second virtual object and that the input corresponds to the second type of input allows the computer system automatically perform the fourth operation because the user interface is responsive to the second type of input (e.g., while the second virtual object is not responsive to the second type of input).

In some embodiments, while displaying the user interface: in accordance with a determination that attention of the user is directed to a third virtual object (e.g., the first virtual object, the second virtual object, or another virtual object), emphasizing the third virtual object (e.g., as described with reference to FIG. 11D) (e.g., highlighting, increasing the size of, bolding (e.g., a perimeter of and/or the inside of the third virtual object) (in some embodiments, to indicate that the device is not sensing the second type of input (e.g., or the first type of input); and in accordance with a determination that attention of the user is not directed to the third virtual object, forgoing emphasizing the third virtual object (e.g., not highlighting, increasing the size of, bolding (e.g., a perimeter of and/or the inside of) the third virtual object). Choosing whether or not to emphasize the third virtual object in accordance with a determination that attention of the user is directed to a third virtual object allows the computer system to automatically provide user feedback that the attention of the user is directed to the third virtual object based on prescribed conditions.

In some embodiments, detecting the second type of input causes the computer system to display a system user interface (e.g., as described with reference to FIG. 11H) (e.g., that was not displayed and/or was not previously displayed before the second type of input is detected).

The system user interface is an application switcher user interface (e.g., as described with reference to FIG. 11H and FIGS. 7A-7E) (e.g., a user interface that displays a plurality of user interfaces, where each user interface of the plurality of user interfaces corresponds and/or represents a different application than the other user interfaces of the plurality of user interfaces). In some embodiments, while the application switcher user interface is displayed, the computer system can detect one or more inputs (e.g., a single pinch gesture, a multi-pinch gesture, a pinch and rotate gesture, and/or an air tap gesture); and in response to detecting the one or more inputs, the computer system performs one or more operations (e.g., an operation that switches to one or more different applications and/or an operation that switches to one or more applications that are not displayed in the application switcher user interface and/or that are not currently in focus in the application switcher user interface).

In some embodiments, while displaying the system user interface, the computer system detects a second input (e.g., 750a2) (e.g., a portion of the input and/or an input that is different from the detected input that was detected while displaying the user interface that includes the virtual object and/or with the set of characteristics) that corresponds to a fourth type of input (e.g., that is different from the first type of input and/or the second type of input). In some embodiments, the fourth type of input is a portion of the second type of input (e.g., the fourth type of input is a rotation portion of a pinch and rotate input and/or the fourth type of input is a sliding portion of a pinch and slide input). In response to detecting the second input that corresponds to the fourth type of input, performing an operation with respect to the system user interface that corresponds to the fourth type of input (e.g., as described with reference to FIGS. 7C-7D) (and, in some embodiments, without performing an operation with respect to the first virtual object and/or the second virtual object). In some embodiments, in response to detecting the second input that corresponds to the fourth type of input and in accordance with a determination that the second input is performed in a first direction, the operation with respect to the system user interface that corresponds to the fourth type of input is performed based on the first direction (and not based on a second direction that is different from the first direction). In some embodiments, in response to detecting the second input that corresponds to the fourth type of input and in accordance with a determination that the second input is performed in a second direction that is different from the first direction, the operation with respect to the system user interface that corresponds to the fourth type of input is performed based on the second direction (and not based on the first direction. Performing an operation with respect to the system user interface in response to detecting the second input that corresponds to the fourth type of input allows the user to control the system user interface without cluttering the user interface with additional controls and/or virtual objects.

In some embodiments, in response to detecting the input, the computer system generates a first set of haptic outputs (e.g., 1160a) (e.g., to provide feedback for detecting of the input and/or to indicate detection of the particular type of input (e.g., one or more air pinch, air pinch and hold, air pinch and rotate, and/or air double pinch gestures)). In some embodiments, generating the first set of outputs includes: in accordance with a determination that the input is a first type of input, the first set of haptics include a first type of haptics (e.g., with a first duration, first amplitude, and/or first pattern); and in accordance with a determination that the input is a second type of input, the first set of haptics include a second type of haptics (e.g., with a second duration different from the first duration, second amplitude different from the first amplitude, and/or a second pattern different from the first pattern). In some embodiments, the first set of haptics change overtime and/or occur over time as the input progresses and/or the input is performed. Generating a first set of haptic output in response to detecting the input provides the user with feedback concerning performance of detection of the input, which can also reduce the number of inputs needed to reverse performance of the operation when the user unintentionally causes the audio playback adjustment operation.

In some embodiments, a wrist-worn-wearable device (e.g., 702) (e.g., a smart watch, a wrist-worn fitness tracker, and/or a heart rate monitor) includes the one or more input devices that are used to detect the input (e.g., 244).

In some embodiments, in response to detecting the input, causing the wrist-worn wearable device (e.g., 702) to generate a second set of haptic outputs (e.g., as described with reference to FIG. 11H) (e.g., the first set of haptic outputs described with reference to [claim 13] or a different set of haptic outputs). Causing the wrist-worn wearable device to generate a second set of haptic outputs in response to detecting the input provides the user with feedback concerning performance of detection of the input, which can also reduce the number of inputs needed to reverse performance of the operation when the user unintentionally causes the audio playback adjustment operation.

In some embodiments, the user interface (e.g., 1102) is an extended-reality user interface (e.g., as described with reference to FIG. 11A). In some embodiments, while displaying the extended-reality user interface, the computer system detects inputs and/or the inputs are detected at a computer system that is not displaying the extended-reality user interface.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

In some embodiments, aspects/operations of methods 800, 1000, and/or 1200, as described herein may be interchanged, substituted, and/or added between these methods. For example, the air gesture of method 800 can be the input of method 1200 that is detected while the attention of the user was directed to the first virtual object. For brevity, these details are not repeated here.

As described above, one aspect of the present technology is the gathering and use of data available from various sources to improve XR experiences of users and/or to improve gesture-based input systems. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user and/or to improve gesture-based input systems. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences or gesture-based input experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-78. (canceled)

79. A computer system configured to communicate with one or more input devices, the computer system comprising:
one or more processors; and
memory storing one or more programs configured to be executed by the one or more processors, the one or more programs including instructions for:
detecting, via the one or more input devices, an air gesture that is performed by a hand and that includes a rotation of the hand; and
in response to detecting the air gesture:
in accordance with a determination that the air gesture satisfies a first set of criteria, wherein the first set of criteria includes a criterion that is satisfied when the air gesture was detected while the hand was performing a pinch gesture, performing a first operation based on the air gesture; and
in accordance with a determination that air gesture does not satisfy the first set of criteria, forgoing performing the first operation based on the air gesture.

80. The computer system of claim 79, wherein:
in response to detecting the air gesture and in accordance with a determination that the air gesture satisfies the first set of criteria:
in accordance with a determination that the hand was rotated with a first magnitude of movement, the first operation is performed with a first magnitude of performance; and
in accordance with a determination that the hand was rotated with a second magnitude of movement that is different from the first magnitude of movement, the first operation is performed with a second magnitude of performance that is different from the first magnitude of performance.

81. The computer system of claim 79, wherein:
in response to detecting the air gesture and in accordance with a determination that the air gesture satisfies the first set of criteria:
in accordance with a determination that the hand was rotated at a first speed and the hand was rotated a first angular distance, the first operation is performed with a third magnitude of performance; and
in accordance with a determination that the hand was rotated at the first speed and the hand was rotated a second angular distance that is different from the first angular distance, the first operation is performed with a fourth magnitude of performance that is different from the third magnitude of performance.

82. The computer system of claim 81, wherein the first angular distance is less than the second angular distance, and wherein the third magnitude of performance is greater than the fourth magnitude of performance.

83. The computer system of claim 79, wherein:
in response to detecting the air gesture and in accordance with a determination that the air gesture satisfies the first set of criteria:
in accordance with a determination that the hand was rotated in a first direction, the first operation is performed based on the first direction; and
in accordance with a determination that the hand was rotated in a second direction that is different from the first direction, the first operation is performed based on the second direction.

84. The computer system of claim 79, the one or more programs further including instructions for:
in response to detecting the air gesture and in accordance with a determination that the air gesture satisfies the first set of criteria, initiating a process for generating a set of one or more haptic outputs that indicates that the air gesture satisfies the first set of criteria.

85. The computer system of claim 84, wherein the computer system is in communication with a wearable device, and wherein initiating the process for generating haptic feedback includes sending one or more instructions that causes the wearable device to generate the set of one or more haptic outputs that indicates that the air gesture satisfies the first set of criteria.

86. The computer system of claim 79, wherein performing the first operation based on the air gesture includes transitioning through a first sequence of states, and the one or more programs further including instructions for:
while transitioning through the first sequence of states:
in accordance with a determination that a first state in the first sequence of states has been reached, generating a set of one or more haptic outputs that indicates the first state in the first sequence of states has been reached; and
in accordance with a determination that a second state in the first sequence of states has been reached, wherein the second state is different from the first state, generating a set of one or more haptic outputs that indicates that the second state in the first sequence of states have been reached.

87. The computer system of claim 79, wherein performing the first operation based on the air gesture includes transitioning through a second sequence of states, and the one or more programs further including instructions for:
while transitioning through the second sequence of states, detecting that a particular state in the second sequence of states has been reached; and
in response to detecting that the particular state has been reached, generating a set of one or more haptic outputs that indicates that the particular state in the second sequence of states has been reached.

88. The computer system of claim 79, the one or more programs including further instructions for:
while performing the first operation based on the air gesture, detecting a first change to the air gesture that includes the rotation of the hand; and
in response to detecting the first change to the air gesture that includes the rotation of the hand and in accordance with a determination that the rotation of the hand has stopped while the hand has continued to perform the pinch gesture, continuing to perform the first operation.

89. The computer system of claim 79, the one or more programs further including instructions for:
while performing the first operation based on the air gesture, detecting a second change to the air gesture that includes the rotation of the hand; and
in response to detecting the second change to the air gesture that includes the rotation of the hand and in accordance with a determination that the hand has changed from being rotated in a first direction to be rotated in a second direction that is different from the first direction, ceasing to perform the first operation.

90. The computer system of claim 79, the one or more programs further including instructions for:
while performing the first operation based on the air gesture:
in accordance with a determination that a first portion of the first operation is being performed, generating a set of one or more haptic outputs that indicate that the first portion of the first operation is being performed; and
in accordance with a determination that a second portion of the first operation is being performed, wherein the second portion of the first operation is different from the first portion of the first operation, generating a set of one or more haptic outputs that indicate that the second portion of the first operation is being performed.

91. The computer system of claim 79, wherein performing the first operation based on the air gesture includes:
in accordance with a determination that the air gesture is being performed at a first speed, generating a set of haptics that indicate that the air gesture is being performed at the first speed; and
in accordance with a determination that the air gesture is being performed at a second speed that is different from the first speed, generating a set of haptics that indicate that the air gesture is being performed a second speed that is different from the first speed.

92. The computer system of claim 79, wherein the first operation is performed at a first rate in response to detecting the air gesture, and the one or more programs further including instructions for:
while performing the first operation at the first rate, detecting an additional rotation of the hand while the hand is performing the pinch gesture; and
in response to detecting the additional rotation of the hand while the hand is performing the pinch gesture, performing the first operation at a second rate that is different from the first rate.

93. The computer system of claim 79, the one or more programs further including instructions for:
while performing the first operation based on the air gesture, detecting a third change to the air gesture that includes the rotation of the hand; and
in response to detecting the third change to the air gesture that includes the rotation of the hand and in accordance with a determination that the hand is no longer performing the pinch gesture, forgoing performance of the first operation.

94. The computer system of claim 79, wherein the first operation is an operation that is performed with respect to one or more virtual objects in an extended reality environment.

95. The computer system of claim 79, wherein the computer system is in communication with a display generation component, and wherein the first set of criteria includes a criterion that is satisfied when the display generation component is in an active state.

96. The computer system of claim 79, wherein the air gesture is detected while displaying a first virtual object and a second virtual object that is different from the first virtual object, and wherein:
in response to detecting the air gesture:
in accordance with a determination that the air gesture satisfies the first set of criteria while attention of a user is directed to the first virtual object, the first operation is performed with respect to the first virtual object; and
in accordance with a determination that the air gesture satisfies the first set of criteria while attention of the user is directed to the second virtual object, the first operation is performed with respect to the second virtual object.

97. The computer system of claim 79, wherein the air gesture is detected while displaying a third virtual object, and wherein:
in response to detecting the air gesture:
in accordance with a determination that the air gesture satisfies the first set of criteria while attention of a user is directed to the third virtual object and the third virtual object is responsive to a rotation of the hand, the first operation is performed with respect to the third virtual object and based on movement of the hand; and
in accordance with a determination that the air gesture satisfies the first set of criteria while attention of the user is directed to the third virtual object and the third virtual object is responsive to a rotation of the hand, the first operation is not performed with respect to the third virtual object.

98. The computer system of claim 79, wherein the first set of criteria includes a criterion that is satisfied when attention of a user is directed to a first location, and wherein attention of the user is determined based on a gaze of the user being directed to the first location.

99. The computer system of claim 79, wherein the first set of criteria includes a criterion that is satisfied when attention of a user is directed to a second location, and wherein attention of the user is determined based on the hand of the user being within a predetermined distance away from the second location.

100. The computer system of claim 79, wherein performing the first operation based on the air gesture includes:
in response to detecting a first portion of the air gesture that includes a pinch and hold gesture, displaying a plurality of virtual objects that includes a virtual object that corresponds to a first application; and
while displaying the plurality of virtual objects and while continuing to detect the air gesture, detecting a second portion of the air gesture that includes the rotation of the hand;
in response to detecting the second portion of the air gesture that includes the rotation of the hand, updating an appearance of a user interface that includes the plurality of virtual objects, including indicating that input focus has moved from the virtual object that corresponds to the first application to a virtual object that corresponds to a second application that is different from the first application;
while updating an appearance of a user interface and while indicating that the virtual object that corresponds to the second application has input focus, detecting a third portion of the air gesture that includes release of the pinch and hold gesture; and
in response to detecting the third portion of the air gesture that includes release of the pinch and hold gesture while displaying the virtual object that corresponds to the second application, displaying a user interface that corresponds the second application.

101. A non-transitory computer-readable storage medium storing one or more programs configured to be executed by one or more processors of a computer system that is in communication with one or more input devices, the one or more programs including instructions for:
detecting, via the one or more input devices, an air gesture that is performed by a hand and that includes a rotation of the hand; and
in response to detecting the air gesture:
in accordance with a determination that the air gesture satisfies a first set of criteria, wherein the first set of criteria includes a criterion that is satisfied when the air gesture was detected while the hand was performing a pinch gesture, performing a first operation based on the air gesture; and
in accordance with a determination that air gesture does not satisfy the first set of criteria, forgoing performing the first operation based on the air gesture.

102. A method, comprising:
at a computer system that is in communication with one or more input devices:
detecting, via the one or more input devices, an air gesture that is performed by a hand and that includes a rotation of the hand; and
in response to detecting the air gesture:
in accordance with a determination that the air gesture satisfies a first set of criteria, wherein the first set of criteria includes a criterion that is satisfied when the air gesture was detected while the hand was performing a pinch gesture, performing a first operation based on the air gesture; and
in accordance with a determination that air gesture does not satisfy the first set of criteria, forgoing performing the first operation based on the air gesture.
